(19) United States
(12) Patent Application Publication
(10) Pub. No.: US 2007/0128380 A1
(43) Pub. Date: Jun. 7, 2007

(54) Cellulose Ester Film, Its Manufacturing Method, Polarizing Plate, and Liquid Crystal Display

(75) Inventors: Norio MIURA, Tokyo (JP); Satomi KAWABE, Tokyo (JP); Takayuki SUZUKI, Tokyo (JP); Kazuaki NAKAMURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 11/563,304

(22) Filed: Nov. 27, 2006

(30) Foreign Application Priority Data
Dec. 7, 2005 (JP) JP2005-353229

(51) Int. Cl. C09K 19/00

(52) U.S. Cl. 428/1.31

(57) ABSTRACT

Disclosed is a cellulose ester film comprising cellulose ester and a phosphonite compound.

This application is based on Japanese Patent Application No. 2005-353229, filed on Dec. 07, 2005 in Japanese Patent Office, the entire content of which is hereby incorporated by reference.

### FIELD OF THE INVENTION

The present invention relates to cellulose ester film containing cellulose ester and a phosphonite compound, its manufacturing method, a polarizing plate employing the cellulose ester film, and a liquid crystal display employing the polarizing plate.

### BACKGROUND OF THE INVENTION

Liquid crystal displays (LCDs) are widely used as display devices in products such as word processors and personal computers, television sets, monitors, and mobile information terminals because they can be directly connected to an IC circuit, operated at low voltage and low power consumption, and formed into thin devices. The basic structure of the LCD is comprised, for example, of a polarizing plate provided on both sides of a liquid crystal cell.

Incidentally, the polarizing plate only allows light of a fixed direction in the polarizing plane to pass. The LCD thus has the important role of making visible the changes in the orientation of the liquid crystal caused by an electric field. In other words, the performance of the polarizing plate greatly affects the performance of the LCD.

The polarizer of the polarizing plate is one in which iodine and the like is adsorbed on a high molecular weight polymer film and is then extruded. That is to say, a solution, called H ink which includes a two-colored substance (iodine), is adsorbed by wet adsorption onto a polyvinyl alcohol film and then the two-colored substance is oriented in one direction due to uniaxial extrusion of the film. Cellulose resin, and cellulose triacetate in particular, may be used as the polarizing plate protective film.

Cellulose ester film is optically and physically effective as a polarizing plate protective film and is thus widely used. However, because the method for manufacturing the film is a casting method using a halogen-based solvent, the cost required to recover the solvent is an extremely large negative factor.

In recent years, as a manufacturing method of cellulose ester film for application to a polarizing plate protective film, a melt cast method has been carried out (see for example, Japanese Patent O.P.I. Publication No. 2000-352620). However, since cellulose ester is a polymer having a high glass transition temperature and a very high viscosity at molten state, cellulose ester film, which is formed when cellulose ester is melted and extruded from dice to be cast on a cooling drum or on a cooling belt, is difficult to level, and solidifies in a short time after extruded. It has been found that there are problems in that such a cellulose ester film is poor in physical properties such as flatness, anti-curling and dimensional stability, and in uniformity of retardation as an optical property, particularly in uniformity of retardation in the width direction of the film, as compared with cellulose ester film obtained according to a solution cast method.

The melt cast method for manufacturing a cellulose ester film, comprising a heat application step (process) at a high temperature exceeding 150° C., has problem that coloration or processing stability lowering of the film results from reduction of cellulose ester molecular weight due to thermal decomposition. In order to solve such problem, there is proposed a method in which a hindered phenol compound, a hindered amine compound or an acid scavenger is added as a stabilizer in a specific amount to a cellulose ester film, thereby coloration or processing stability lowering of the film is minimized (see, for example, Japanese Patent O.P.I. Publication No. 2003-192920.). Further, there is proposed a method in which a polyhydric alcohol ester is added as a plasticizer to a cellulose ester film in order to lower a melt viscosity (see, for example, Japanese Patent O.P.I. Publication No. 2003-12823.). However, the methods as described above are still insufficient to overcome the above-described problems, i.e., lowering of uniformity of retardation as an optical property, and coloration or processing stability lowering, resulting from reduction of cellulose ester molecular weight.

A phosphonite compound is well-known as a compound preventing deterioration of various organic polymers (see, for example, Japanese Patent O.P.I. Publication Nos. 1-20249, 5-178870, 7-33969, 7-62162, 7-62238, 8-165375, 9-100346, 2000-178384, 2001-310972, 2002-248416, 2003-96089, 2003-292954, and 5-194785.). A cyclic polyolefin resin composition is known which comprises, as a stabilizer, a phosphonite compound, a phosphite, and/or a hindered phenol compound (see Japanese Patent O.P.I. Publication Nos. 2001-261943.). An organic polymer composition is known which comprises, as a stabilizer, a phosphonite compound, a phosphite, and/or a hindered phenol compound (see WO 99/54394.).

However, the phosphonite compound has not hitherto been studied as a compound improving uniformity of retardation as an optical property of a cellulose ester film, particularly uniformity of retardation in the transverse direction of a cellulose ester film.

### SUMMARY OF THE INVENTION

An object of the invention is to provide a cellulose ester film, which is reduced in a manufacturing load, a facility load and an environmental load, each being accompanied with evaporation or recovery (collection) of solvents on film manufacture, and which has excellent optical properties such as high transparency and small variation of retardation in the transverse direction of the film, less coloration and high processing stability, and to provide a manufacturing process of the cellulose ester film.

Another object of the invention is to provide a polarizing plate employing the cellulose ester film as its polarizing plate protecting film and a liquid crystal display employing the polarizing plate.

### DETAILED DESCRIPTION OF THE INVENTION

The above object of the invention can be attained by any one of the following constitutions.

1. A cellulose ester film comprising cellulose ester and a phosphonite compound.

2. The cellulose ester film of item 1 above, wherein the phosphonite compound is represented by the following formula 1 or 2,
R₁P(OR₂)₂ Formula 1
wherein R₁ represents a substituted or unsubstituted phenyl group or a thienyl group; and R₂ represents an alkyl group having a carbon atom number of from 1 to 6, a phenyl group, a thienyl group or a substituted phenyl group having one to five substituents with a total carbon atom number of from 1 to 14, provided that the two R₂s may combine with each other to form a ring.
(OR₄)₂P—R₃—R₃—P(OR₄)₂ Formula 2
wherein R₃ represents a substituted or unsubstituted phenylene group or a thienylene group; and R₄ represents an alkyl group having a carbon atom number of from 1 to 6, a phenyl group, a thienyl group or a substituted phenyl group having one to five substituents with a total carbon atom number of from 1 to 14, provided that the two R₄s may combine with each other to form a ring.

3. The cellulose ester film of item 1 or 2 above, wherein the content of the phosphonite compound in the cellulose ester film is from 0.01 to 5 parts by weight, based on 100 parts by weight of the cellulose ester.

4. The cellulose ester film of any one of items 1 through 3 above, wherein the cellulose ester film further contains a phosphite compound in an amount of from 0.01 to 5 parts by weight, based on 100 parts by weight of the cellulose ester.

5. The cellulose ester film of any one of items 1 through 4 above, wherein the cellulose ester film further contains at least one selected from the group consisting of a hindered phenol compound, a hindered amine compound and a sulfur-containing compound in an amount of from 0.01 to 5 parts by weight, based on 100 parts by weight of the cellulose ester.

6. The cellulose ester film of any one of items 1 through 5 above, wherein the cellulose ester is at least one selected from the group consisting of cellulose acetate, cellulose propionate, cellulose butyrate, cellulose acetate propionate, cellulose acetate butyrate, cellulose acetate phthalate, and cellulose phthalate.

7. The cellulose ester film of any one of items 1 through 6 above, wherein the cellulose ester further contains an ester plasticizer formed from a polyhydric alcohol and a monocarboxylic acid.
8. The cellulose ester film of item 2 above, wherein the phosphonite compound is represented by formula 2 above.

9. The cellulose ester film of item 8 above, wherein R₄ in formula 2 represents a substituted phenyl group having one to five substituents with a total carbon atom number of from 9 to 14.

10. The cellulose ester film of item 9 above, wherein the phosphonite compound is tetrakis(2,4-di-t-butyl-5-methylphenyl) 4,4′-biphenylenediphosphonite.

11. The cellulose ester film of any one of items 1 through 10 above, wherein the cellulose ester film further contains a carbon radical trapping agent.

12. The cellulose ester film of item 11 above, wherein the carbon radical trapping agent is represented by the following formula 5, 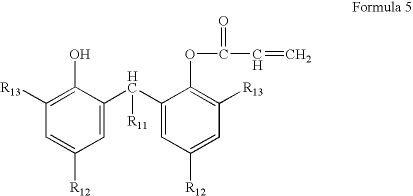
wherein R₁₁ represents a hydrogen atom or an alkyl group having a carbon atom number of from 1 to 10; R₁₂ and R₁₃ independently represent an alkyl group having a carbon atom number of from 1 to 8.

13. The cellulose ester film of item 11 above, wherein the carbon radical trapping agent is represented by the following formula 6, 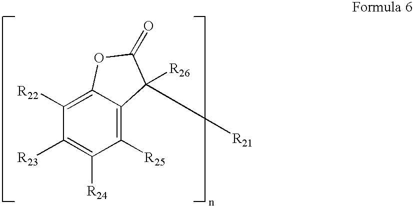
wherein R₂₂ through R₂₅ independently represent a hydrogen atom or a substituent; R₂₆ represents a hydrogen atom or a substituent; and n is 1 or 2, provided that when n is 1, R₂₁ represents a monovalent substituent, and when n is 2, R₂₁ represents a divalent linkage group.

14. A process of manufacturing the cellulose ester film of item 1 above, the process comprising the steps of:

heating a mixture comprising cellulose ester and a phosphonite compound at a temperature of from 150 to 300° C. to melt; and

casting the melted mixture on a support.

15. A polarizing plate comprising a polarizing plate protective film, wherein the polarizing plate protective film is the cellulose ester film of any one of items 1 through 13 above.

16. A polarizing plate comprising a polarizing plate protective film, wherein the polarizing plate protective film is the cellulose ester film manufactured according to the process of item 14 above.

17. A liquid crystal display comprising a liquid crystal cell and the polarizing plate of item 15 above.

18. A liquid crystal display comprising a liquid crystal cell and the polarizing plate of item 16 above.

The invention will be explained in detail below.

A solution cast method as one of cellulose ester film manufacturing methods comprises the steps of casting on a support a cellulose ester solution in which the cellulose ester is dissolved in a solvent to form a wet cellulose ester web on the support, and evaporating the solvent in the web, whereby the web is dried to obtain a cellulose ester film. This method requires removal of the residual solvent of the wet cellulose ester web, and therefore, it requires energy for drying, an apparatus for collecting the evaporated solvent, and an apparatus for regenerating the collected solvent, resulting in increase of appliance investment and manufacturing cost. Reduction of the appliance investment and manufacturing cost has been sought.

In contrast, a melt cast method does not employ a solvent for dissolving cellulose ester, and therefore, does not have load for appliance investment or drying.

The present inventors have made an extensive study on cellulose ester film, and as a result, they have found that a cellulose ester film (for example, used as a protective film for a polarizing plate) containing a phosphonite compound provides surprising results that uniformity of retardation is greatly improved. At the same time it has proved that coloration or lowering of processability of the cellulose ester film is minimized which is caused by thermal decomposition (reduction of molecular weight) of the cellulose ester during melting. The improvement of uniformity of retardation is enhanced by addition of a phosphite to the cellulose ester film, and further enhanced by addition of a hindered phenol compound, a hindered amine compound or a sulfur-containing compound to the cellulose ester film. An ester plasticizer formed from a polyhydric alcohol and a monocarboxylic acid has high affinity to cellulose ester, and improves optical properties or processability of a cellulose ester film containing the ester plasticizer. Further, it has proved that a cellulose ester film containing a phosphonite compound provides the surprising result of improving transparency of the film. It has been found that the above described advantages can be obtained by a melt cast method, providing cellulose ester film having properties equal to or higher than that obtained by a solution cast method.

Next, compounds used in the invention will be explained in detail.

(Phosphonite Compound)

As the phosphonite compound in the invention can be used known phosphonite compounds, for example, those disclosed in Japanese Patent O.P.I. Publication Nos. 1-20249, 5-178870, 7-33969, 7-62162, 7-62238, 8-165375, 9-100346, 2000-178384, 2001-310972, 2002-248416, 2003-96089 and 2003-292954 described above.

In the invention, the phosphonite compound represented by formula 1 or 2 described above is preferred.

In formula 1 above, R₁ represents a substituted or unsubstituted phenyl group or a thienyl group; and R₂ represents an alkyl group having a carbon atom number of from 1 to 6, a phenyl group, a thienyl group or a substituted phenyl group having one to five substituents having a total carbon atom number of from 1 to 14, provided that the two R₂s may combine with each other to form a ring. R₂ is preferably a substituted phenyl group having, as a substituent, an alkyl group with a carbon atom number of from 1 to 9. R₂ is preferably a substituted phenyl group whose substituent has a total carbon atom number of 9 to 14, and preferably 9 to 11. When the two R₂s combine with each other to form a ring, the total carbon atom number of substituents on the phenyl group is preferably from 10 to 30.

The substituent is not specifically limited, but examples of the substituent include an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoylamino group), an alkylthio group (for example, a methylthio group, or an ethylthio group), an arylthio group (for example, a phenylthio group or a naphthylthio group), an alkenyl group (for example, a vinyl group, 2-propenyl group, a 3-butenyl group, a 1-methyl-3-propenyl group, a 3-pentenyl group, a 1-methyl-3-butenyl group, a hexenyl group or a cyclohexenyl group), a halogen atom (for example, fluorine, chlorine, bromine, iodine), an alkinyl group (for example, a propargyl group), a heterocyclic group (for example, pyridyl group, a thiazolyl group, an oxazolyl group or an imidazolyl group), an alkylsulfonyl group (for example, a methylsulfonyl group or an ethylsulfonyl group), an arylsulfonyl group (for example, a phenylsulfonyl group or a naphthylsulfonyl group), a sulfinyl group (for example, a methylsulfinyl group), an arylsulfonyl group (a phenylsulfinyl group), a phosphono group, an acyl group (for example, an acetyl group, a pivaloyl group or a benzoyl group), a carbamoyl group (for example, an aminocarbonyl group, a methylaminocarbonyl group, a dimethylaminocarbonyl group, a butylaminocarbonyl group, a cyclohexylaminocarbonyl group, a phenylaminocarbonyl group, or a 2-pyridylaminocarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group), a sulfonamide group (for example, a methanesulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycleoxy group, a silyloxy group, an acyloxy group (for example, an acetyloxy group, or a benzoyloxy group), a sulfonic acid group, a sulfonate group, an aminocarbonyloxy group, an amino group (for example, an amino group, an ethylamino group, a dimethylamino group, a butylaminocarbonyl group, a cyclopentylamino group, a 2-ethylhexylamino group, or a dodecylamino group), an amino group (for example, a phenylammino group, a chlorophenylammino group, a toluidino group, an anisidino group, a naphthylamino group or a 2-pyridylamino group), an imino group, a ureido group (for example, a methylureido group, an ethylureido group, a pentylureido group, a cyclohexylureido group, an octylureido group, a dodecylureido group, a phenylureido group, a naphthylureido group, or a 2-pyridylureido group), an alkoxycarbonylamino group (for example, a methoxycarbonylamino group or a phenoxycarbonylamino group), an alkoxycarbonyl group (for example, a methoxycarbonyl group or an ethoxycarbonyl group), an aryloxycarbonyl group (for example, a phenoxycarbonyl group), a heterocyclicthio group, a thioureido group, a carboxyl group, a carboxylate group, a hydroxyl group, a mercapto group, and a nitro group. These substituents may further have the substituent as described above.

In formula 2, R₃ represents a phenylene group or a thienylene group; and R₄ represents an alkyl group having a carbon atom number of from 1 to 6, a phenyl group, a thienyl group or a substituted phenyl group having one to five substituents having a total carbon atom number of from 1 to 14, provided that the two R₄s may combine with each other to form a ring. R₄ is preferably a substituted phenyl group having, as a substituent, an alkyl group with a carbon atom number of from 1 to 9. R₄ is preferably a substituted phenyl group whose substituent has a total carbon atom number of 9 to 14, and preferably 9 to 11. When the two R₄s combine with each other to form a ring, the total carbon atom number of substituents on the phenyl group is preferably from 10 to 30.

The substituent is the same as those denoted in R₂ of formula 1.

Examples of the phosphonite compound represented by formula 1 include dialkyl phenylphosphonites such as dimethyl phenylphosphonite and di-t-butyl phenylphosphonite; and di(substituted or unsubstituted phenyl)phenylphosphonite such as diphenyl phenylphosphonite, di(4-pentylphenyl)phenylphosphonite, di(2-t-butylphenyl)phenylphosphonite, di(2-metyl-3-pentylphenyl)phenylphosphonite, di(2-metyhyl-ocylphenyl)phenylphosphonite, di(3-butyl-4-methylphenyl)phenylphosphonite, di(3-hexyl-4-ethylphenyl)phenylphosphonite, di(2,4,6-trimethylphenyl)phenylphosphonite, di(2,3-dimethyl-4-ethylphenyl)phenylphosphonite, di(2,6-diethyl-3-butylphenyl)phenylphosphonite, di(2,3-diproyl-5-butylphenyl)phenylphosphonite, and di(2,4,6-tri-t-butylphenyl)phenylphosphonite.

Examples of the phosphonite compound represented by formula 2 include tetrakis(2,4-di-t-butylphenyl) 4,4′-biphenylenediphosphonite, tetrakis(2,5-di-t-butylphenyl) 4,4′-biphenylenediphosphonite, tetrakis(3,5-di-t-butylphenyl) 4,4′-biphenylenediphosphonite, tetrakis(2,3,4-trimethylphenyl) 4,4′-biphenylenediphosphonite, tetrakis(2,3-dimethyl-5-ethylphenyl) 4,4′-biphenylenediphosphonite, tetrakis(2,3-dimethyl-4-propylphenyl) 4,4′-biphenylenediphosphonite, tetrakis(2,3-dimethyl-5-t-butylphenyl) 4,4′-biphenylenediphosphonite, tetrakis(2,3-dimethyl-4-t-butylphenyl) 4,4′-biphenylenediphosphonite, tetrakis(2,3-diethyl-5-methylphenyl) 4,4′-biphenylenediphosphonite, tetrakis(2,3-diethyl-4-methylphenyl) 4,4′-biphenylenediphosphonite, tetrakis(2,4,5-triethylphenyl) 4,4′-biphenylenediphosphonite, tetrakis(2,6-diethyl-4-propylphenyl) 4,4′-biphenylenediphosphonite, tetrakis(2,5-diethyl-6-butylphenyl) 4,4′-biphenylenediphosphonite, tetrakis(2,3-diethyl-5-t-butylphenyl) 4,4′-biphenylenediphosphonite, tetrakis(2,5-diethyl-6-t-butylphenyl) 4,4′-biphenylenediphosphonite, tetrakis(2,3-dipropyl-5-methylphenyl) 4,4′-biphenylenediphosphonite, tetrakis(2,6-dipropyl-4-methylphenyl) 4,4′-biphenylenediphosphonite, tetrakis(2,6-dipropyl-5-ethylphenyl) 4,4′-biphenylenediphosphonite, tetrakis(2,3-dipropyl-6-butylphenyl) 4,4′-biphenylenediphosphonite, tetrakis(2,6-dipropyl-5-butylphenyl) 4,4′-biphenylenediphosphonite, tetrakis(2,3-dibutyl-4-methylphenyl) 4,4′-biphenylenediphosphonite, tetrakis(2,5-dibutyl-3-methylphenyl) 4,4′-biphenylenediphosphonite, tetrakis(2,6-dibutyl-4-methylphenyl) 4,4′-biphenylenediphosphonite, tetrakis(2,4-di-t-butyl-3-methylphenyl) 4,4′-biphenylenediphosphonite, tetrakis(2,4-di-t-butyl-5-methylphenyl) 4,4′-biphenylenediphosphonite, tetrakis(2,4-di-t-butyl-6-methylphenyl) 4,4′-biphenylenediphosphonite, tetrakis(2,5-di-t-butyl-3-methylphenyl) 4,4′-biphenylenediphosphonite, tetrakis(2,5-di-t-butyl-4-methylphenyl) 4,4′-biphenylenediphosphonite, tetrakis(2,5-di-t-butyl-6-methylphenyl) 4,4′-biphenylenediphosphonite, tetrakis(2,6-di-t-butyl-3-methylphenyl) 4,4′-biphenylenediphosphonite, tetrakis(2,6-di-t-butyl-4-methylphenyl) 4,4′-biphenylenediphosphonite, tetrakis(2,6-di-t-butyl-5-methylphenyl) 4,4′-biphenylenediphosphonite, tetrakis(2,3-dibutyl-4-ethylphenyl) 4,4′-biphenylenediphosphonite, tetrakis(2,4-dibutyl-3-ethylphenyl) 4,4′-biphenylenediphosphonite, tetrakis(2,5-dibutyl-4-ethylphenyl) 4,4′-biphenylenediphosphonite, tetrakis(2,4-di-t-butyl-3-ethylphenyl) 4,4′-biphenylenediphosphonite, tetrakis(2,4-di-t-butyl-5-ethylphenyl) 4,4′-biphenylenediphosphonite, tetrakis(2,4-di-t-butyl-6-ethylphenyl) 4,4′-biphenylenediphosphonite, tetrakis(2,5-di-t-butyl-3-ethylphenyl) 4,4′-biphenylenediphosphonite, tetrakis(2,5-di-t-butyl-4-ethylphenyl) 4,4′-biphenylenediphosphonite, tetrakis(2,5-di-t-butyl-6-ethylphenyl) 4,4′-biphenylenediphosphonite, tetrakis(2,6-di-t-butyl-3-ethylphenyl) 4,4′-biphenylenediphosphonite, tetrakis(2,6-di-t-butyl-4-ethylphenyl) 4,4′-biphenylenediphosphonite, tetrakis(2,6-di-t-butyl-5-ethylphenyl) 4,4′-biphenylenediphosphonite, tetrakis(2,3,4-tributylphenyl) 4,4′-biphenylenediphosphonite, and tetrakis(2,4,6-tri-t-butylphenyl) 4,4′-biphenylenediphosphonite.

In the invention, the phosphonite compound represented by formula 2 is preferred. Among these, 4,4′-biphenylenediphosphonites such as tetrakis(2,4-di-t-butylphenyl) 4,4′-biphenylenediphosphonite are preferred, and tetrakis(2,4-di-t-butyl-5-methylphenyl) 4,4′-biphenylenediphosphonite is especially preferred.

Preferred examples of the phosphonite compounds will be listed below.

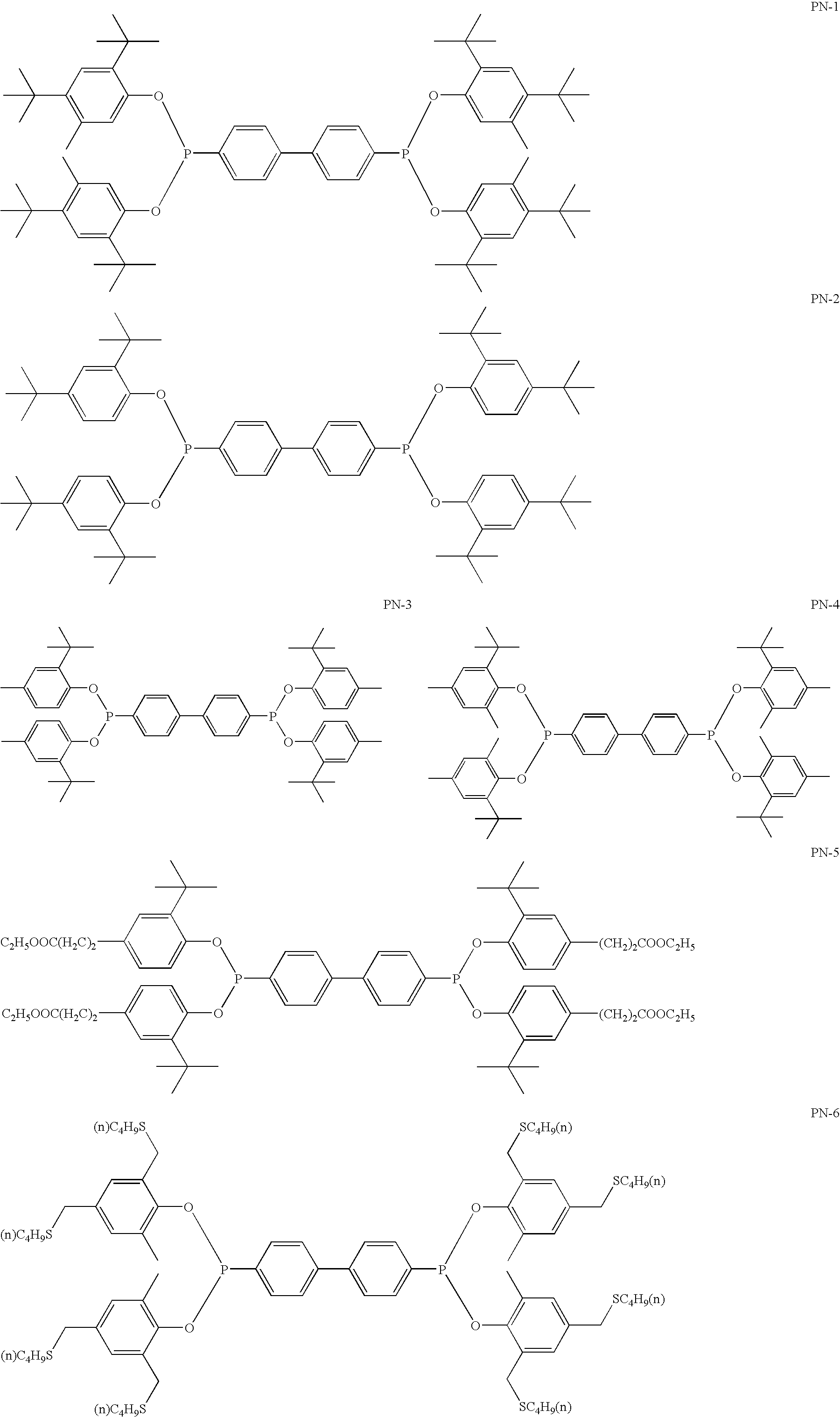

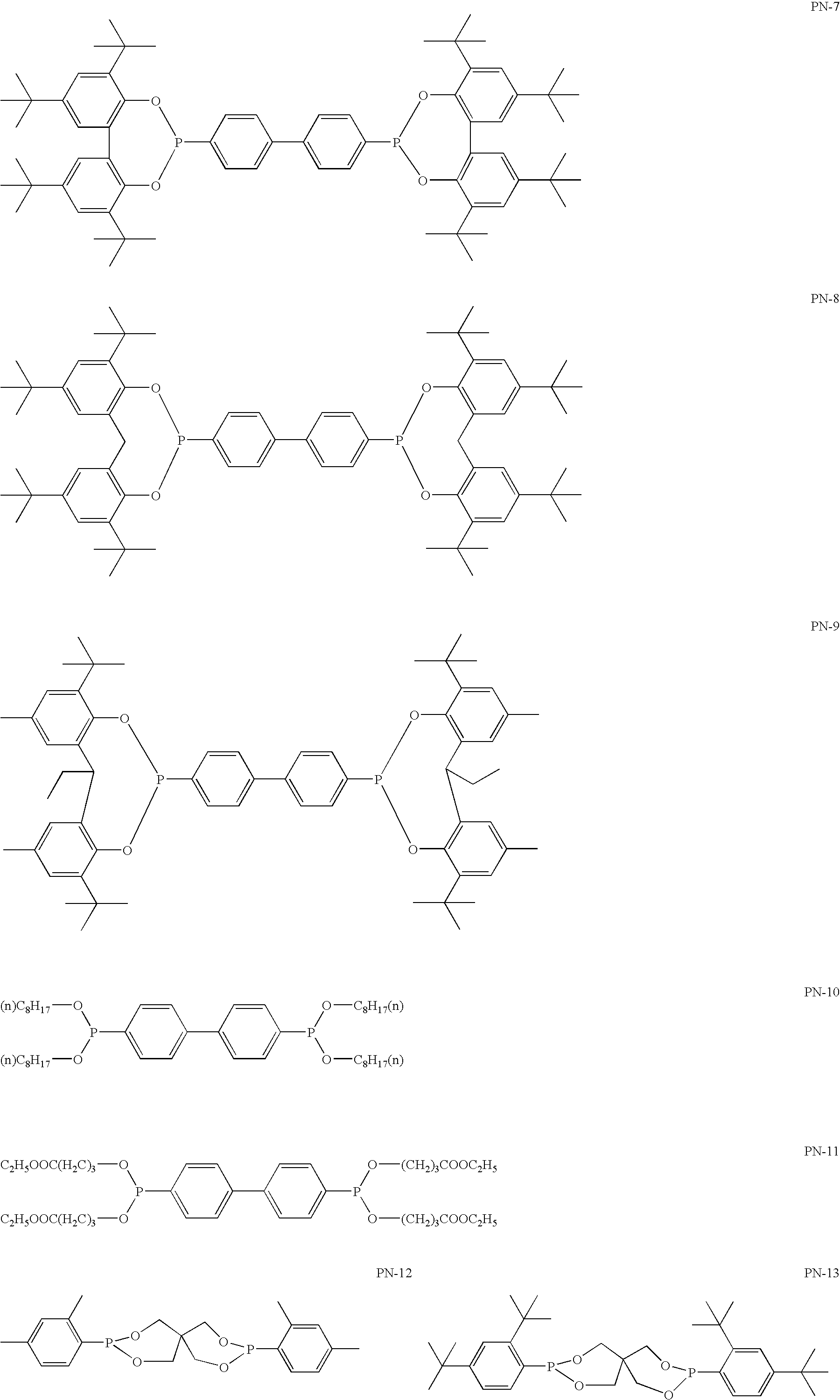

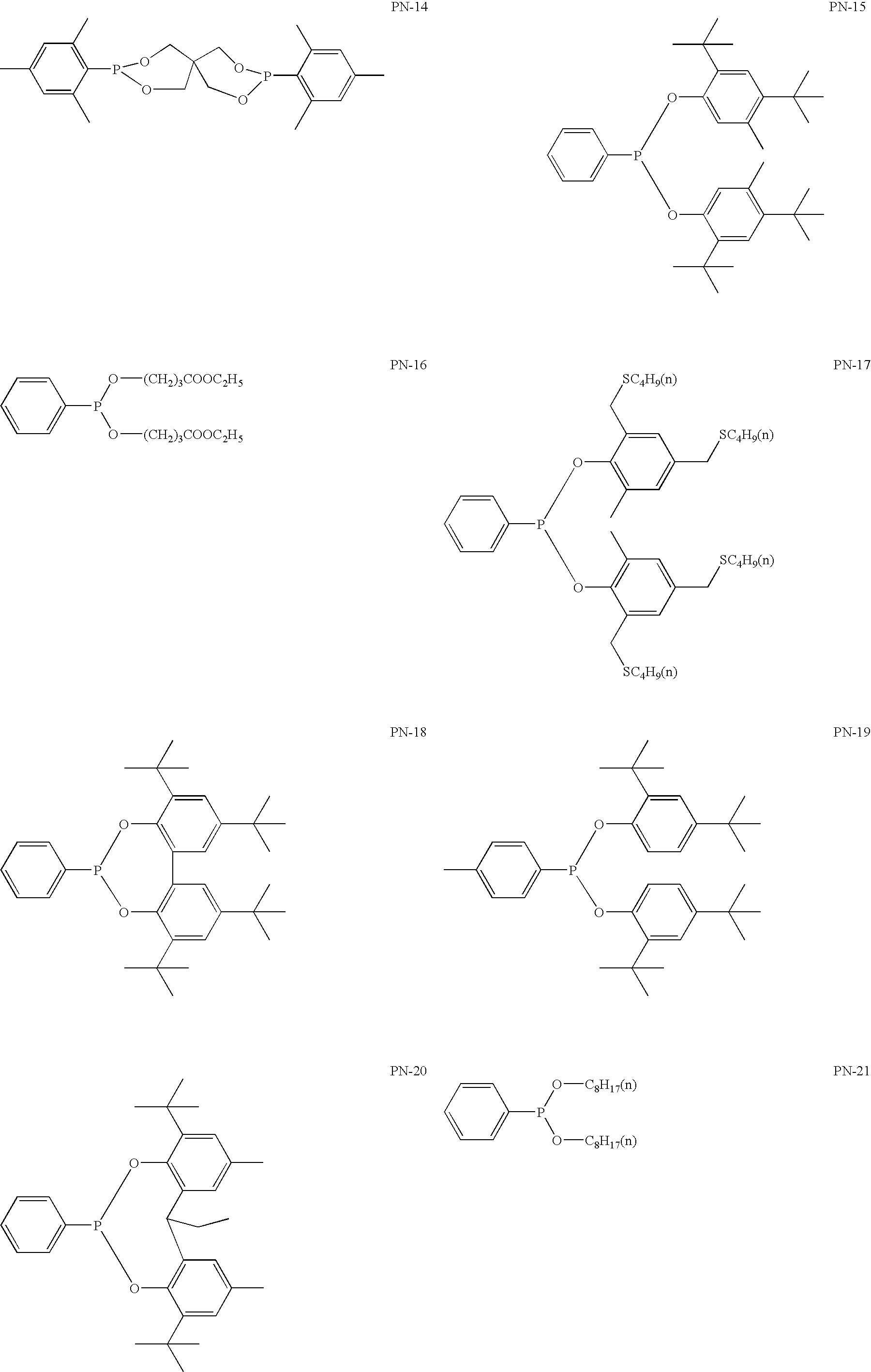

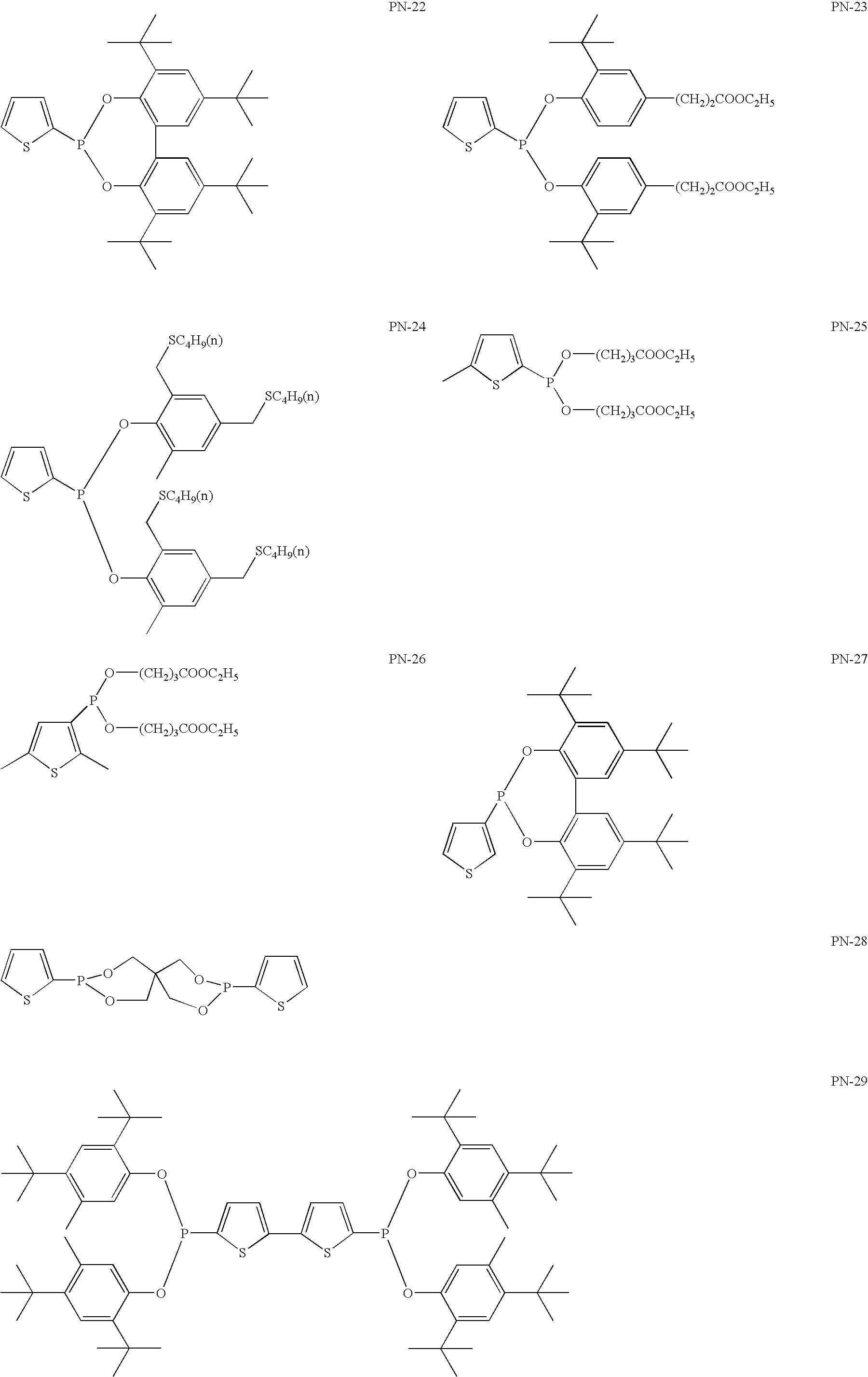

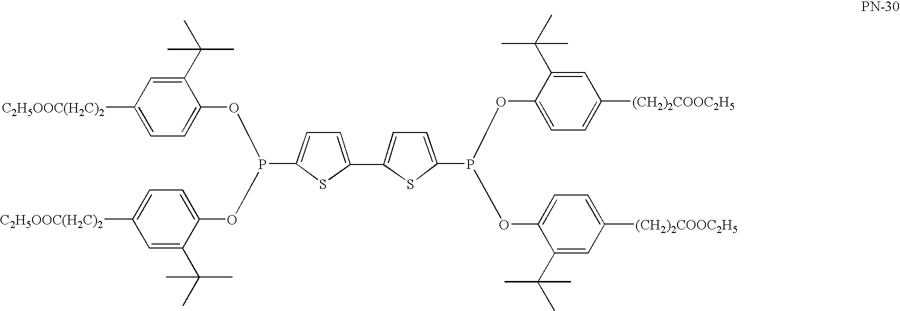

The content of the phosphonite compound in the cellulose ester film is ordinarily from 0.001 to 10.0 parts by weight, preferably from 0.01 to 5.0 parts by weight, and more preferably 0.1 to 3.0 parts by weight, based on 100 parts by weight of cellulose ester.

(Phosphite Compound)

The cellulose ester film of the invention preferably contains a phosphite compound. The phosphite compound used in the invention is not specifically limited, as long as it is one used in general resin industries. Examples thereof include a monophosphite compound such as triphenyl phosphite, diphenyl isodecylphosphite, phenyl diisodecyl phosphite, tris(nonylphenyl)phosphite, tris(dinonylphenyl)phosphite, tris(2,4-di-t-butylphenyl)phosphite, or 10-(3,5-di-t-butyl-4-hydroxybenzyl)-9,10-dihydro-9-oxa-10-phosphaphenanthrene-10-oxide; and a diphosphite compound such as 4,4′-butylidene-bis(3-methyl-6-t-butylphenyl-di-tridecyl phosphite) and 4,4′-isopropylidene-bis(phenyl-dialkyl(C12-C15)phosphite). Of these, monophosphite compounds are preferred, and tris(nonylphenyl)phosphite, tris(dinonylphenyl)phosphite and tris(2,4-di-t-butylphenyl)phosphite are more preferred. A still more preferred phosphite is represented by the following formula 3.

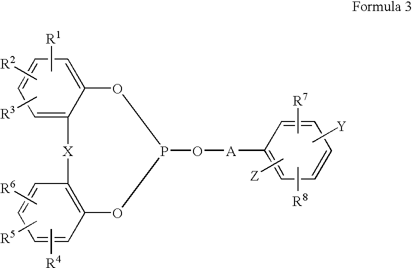

In formula 3, R¹, R², R⁴, R⁵, R⁷ and R⁸ independently represent a hydrogen atom, an alkyl group having 1 to 8 carbon atoms, a cycloalkyl group having 5 to 8 carbon atoms, an alkylcycloalkyl group having a total carbon atom number 6 to 12, an aralkyl group having a total carbon atom number 7 to 12 or a phenyl group; R³ and R⁶ independently represent a hydrogen atom or an alkyl group having 1 to 8 carbon atoms; X represents a single bond, a sulfur atom or —CHR⁹— in which R⁹ represents a hydrogen atom, an alkyl group having 1 to 8 carbon atoms or a cycloalkyl group having 5 to 8 carbon atoms; A represents an alkylene group having 2 to 8 carbon atoms or *-COR¹⁰—, in which R¹⁰ represents a single bond or an alkylene group having 1 to 8 carbon atoms and * represents a bond combining with the oxygen atom; and one of Y and Z represents a hydroxyl group, an alkoxy group having 1 to 8 carbon atoms or an aralkyloxy group having a total carbon atom number of 7 to 12, and the other a hydrogen atom or an alkyl group having 1 to 8 carbon atoms.

It is preferred that R¹, R² and R⁴ independently represent an alkyl group having 1 to 8 carbon atoms, a cycloalkyl group having 5 to 8 carbon atoms or an alkylcycloalkyl group having a total carbon atom number 6 to 12, a hydrogen atom, and R⁵ represents a hydrogen atom, an alkyl group having 1 to 8 carbon atoms or a cycloalkyl group having 5 to 8 carbon atoms.

In the above, examples of the alkyl group having 1 to 8 carbon atoms include methyl, ethyl, n-propyl, i-propyl, n-butyl, i-butyl, sec-butyl, t-butyl, t-pentyl, i-octyl, t-octyl and 2-ethylhexyl. Examples of the cycloalkyl group having 5 to 8 carbon atoms include cyclopentyl, cyclohexyl, cycloheptyl and cycloctyl. Examples of the alkylcycloalkyl group having a total carbon atom number 6 to 12 include 1-methylcyclopentyl, 1-methylcyclohexyl and 1-methyl-4-isopropylcyclohexyl. Examples of the aralkyl group having a total carbon atom number 7 to 12 include benzyl, α-methylbenzyl and α,α-dimethylbenzyl.

R¹ and R⁴ are preferably a t-alkyl group (e.g., t-butyl, t-pentyl or t-octyl), cyclohexyl, or 1-methylcyclohexyl. R² is preferably alkyl having 1 to 5 carbon atoms, e.g., methyl, ethyl, n-propyl, i-propyl, n-butyl, i-butyl, sec-butyl, t-butyl or t-pentyl, and more preferably methyl, t-butyl or t-pentyl. R⁵ is preferably a hydrogen atom, or alkyl having 1 to 5 carbon atoms, e.g., methyl, ethyl, n-propyl, i-propyl, n-butyl, i-butyl, sec-butyl, t-butyl or t-pentyl.

R³ represents a hydrogen atom or an alkyl group having 1 to 8 carbon atoms. Examples of the alkyl group having 1 to 8 carbon atoms are the same as those denoted in R¹, R² and R⁴ above. R³ is preferably a hydrogen atom or an alkyl group having 1 to 5 carbon atoms, and more preferably a hydrogen atom or methyl.

X represents a single bond, a sulfur atom, methylene or methylene having an alkyl group having 1 to 8 carbon atoms or a cycloalkyl group having 5 to 8 carbon atoms. Herein, examples of the alkyl group having 1 to 8 carbon atoms or the cycloalkyl group having 5 to 8 carbon atoms are the same as those denoted in R¹, R² and R⁴ above. X is preferably a single bond, methylene or methylene having methyl, ethyl, n-propyl, i-propyl, n-butyl, i-butyl or t-butyl.

A represents an alkylene group having 2 to 8 carbon atoms or *—COR¹⁰—, in which R¹⁰ represents a single bond or an alkylene group having 1 to 8 carbon atoms and * represents a bond combining with the oxygen atom. Herein, examples of the alkylene group having 1 to 8 carbon atoms include ethylene, propylene, butylene, pentamethylene, hexamethylene, octamethylene, 2,2-dimethyl-1,3-propylene. R¹⁰ is preferably a single bond or ethylene.

Y and Z represents a hydroxyl group, an alkoxy group having 1 to 8 carbon atoms or an aralkyloxy group having a total carbon atom number of 7 to 12, and the other a hydrogen atom or an alkyl group having 1 to 8 carbon atoms. Herein, examples of the alkyl group having 1 to 8 carbon atoms include those denoted in the alkyl group having 1 to 8 carbon atoms of R¹, R² and R⁴ above, and examples of the alkoxy group having 1 to 8 carbon atoms are an alkoxy group whose alkyl is the same as those denoted in the alkyl group having 1 to 8 carbon atoms of R¹, R² and R⁴ above. Examples of the aralkyloxy group having a total carbon atom number of 7 to 12 are an aralkyloxy group whose aralkyl is the same as those denoted in the aralkyl group having 7 to 12 previously.

Typical examples of the compound represented by formula 3 will be listed below.
Compound 1:
6-[3-(3-tert-butyl-4-hydroxy-5-methylphenyl)propoxy]-2,4,8,10-tetrakis-tert-butyldibenzo[d,f][1.3.2]dioxaphosphepin.
Compound 2:
6-[3-(3,5-di-tert-butyl-4-hydroxyphenyl)propoxy]-2,4,8,10-tetrakis-tert-butyldibenzo[d,f][1.3.2]dioxaphosphepin.

The content of the phosphite compound in the cellulose ester film is ordinarily 0.001 to 10.0 parts by weight, preferably 0.01 to 5.0 parts by weight, and more preferably 0.1 to 3.0 parts by weight, based on 100 parts by weight of cellulose ester.

(Hindered Phenol Compound)

The cellulose ester film of the invention preferably contains a hindered phenol compound. The hindered phenol compounds used in the invention include a 2,6-dialkylphenol compound (as disclosed, for example, in columns 12 to 14 of U.S. Pat. No. 4,839,405). As the hindered phenol compound, there is a compound represented by the following formula 7, 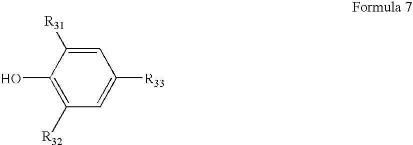
Wherein R₃₁, R₃₂ and R₃₃ independently represent a substituted or unsubstituted alkyl group.

Examples of the hindered phenol compound include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di-t-butyl-4-hydroxybenzoate, n-hexyl 3,5-di-t-butyl-4-hydroxybenzoate, n-dodecyl 3,5-di-t-butyl-4-hydroxybenzoate, neo-dodecyl 3-(3,5-di-t-butyl-4-hydroxyphenyl)propionate, dodecyl β-(3,5-di-t-butyl-4-hydroxyphenyl)propionate, ethyl α-(4-hydroxy-3,5-di-t-butyl-4-hydroxyphenyl)isobutyrate, octadecyl α-(4-hydroxy-3,5-di-t-butyl-4-hydroxyphenyl)isobutyrate, octadecyl α-(4-hydroxy-3,5-di-t-butyl-4-hydroxyphenyl)propionate, 2-(n-octylthio)ethyl 3,5-di-t-butyl-4-hydroxybenzoate, 2-(n-octylthio)ethyl 3,5-di-t-butyl-4-hydroxyphenylacetate, 2-(n-octadecylthio)ethyl 3,5-di-t-butyl-4-hydroxyphenylacetate, 2-(n-octadecylthio)ethyl 3,5-di-t-butyl-4-hydroxybenzoate, phenylacetate, 2-(2-hydroxyethylthio)ethyl 3,5-di-t-butyl-4-hydroxybenzoate, diethylglycol bis(3,5-di-t-butyl-4-hydroxyphenyl)propionate, 2-(n-octadecylthio)ethyl 3-(3,5-di-t-butyl-4-hydroxyphenyl)propionate, stealamide N,N-bis-[ethylene 3-(3,5-di-t-butyl-4-hydroxyphenyl)propionate], n-butylimino N,N-bis-[ethylene 3-(3,5-di-t-butyl-4-hydroxyphenyl)propionate], 2-(2-stearoyloxyethylthio)ethyl 3,5-di-t-butyl-4-hydroxybenzoate, 2-(2-stearoyloxyethylthio)ethyl 7-(3-methyl-5-t-butyl-4-hydroxyphenyl)heptanoate, 1,2-propylene glycol bis[3-(3,5-di-t-butyl-4-hydroxyphenyl)propionate], ethylene glycol bis[3-(3,5-di-t-butyl-4-hydroxyphenyl)propionate], neopentyl glycol bis[3-(3,5-di-t-butyl-4-hydroxyphenyl)propionate], ethylene glycol bis(3,5-di-t-butyl-4-hydroxyphenyl)acetate], glycerin-l-n-octadecanoate-2,3-bis(3,5-di-t-butyl-4-hydroxyphenylacetate), pentaerythritol tetrakis[3-(3′,5′-di-t-butyl-4′-hydroxyphenyl)propionate], 1,1,1-trimethylolethane tris[3-(3,5-di-t-butyl-4-hydroxyphenyl)propionate], sorbitol hexa[3-(3,5-di-t-butyl-4-hydroxyphenyl)propionate], 2-hydroxyethyl 7-(3-methyl-5-t-butyl-4-hydroxyphenyl)heptanoate, 2-stearoyloxyethyl 7-(3-methyl-5-t-butyl-4-hydroxyphenyl)heptanoate, 1,6-n-hexane diol-bis[(3′,5′-di-t-butyl-4′-hydroxyphenyl)propionate], pentaerythritol tetrakis(3,5-di-t-butyl-4-hydroxycinnamate).

As typical examples of the hindered phenol compound above, there are “Irganox 1076” and “Irganox 1010” available from Ciba Specialty Chemicals Co.

(Hindered Amine Compound) The cellulose ester film of the invention preferably contains a hindered amine compound. Examples of the hindered amine compound include bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)2-(3,5-di-t-butyl-4-hydroxybenzyl)-2-butylmalonate, bis(1-acroyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(2,2,6,6-tetramethyl-4-piperidyl) 1,2,3,4-butanetetracarboxylate and tetrakis(1,2,2,6,6-pentamethyl-4-piperidyl) 1,2,3,4-butanetetracarboxylate.

(Sulfur-containing Compound) The cellulose ester film of the invention preferably contains a sulfur-containing compound. Examples of the sulfur-containing compound include dilauryl 3,3-thiodipropionate, dimyristyl 3,3′-thiodipropionate, distearyl 3,3-thiodipropionate, lauryl stearyl 3,3-thiodipropionate, pentaerythritol-tetrakis (β-lauryl-thiopropionate), and 3,9-bis(2-dodecylthioethyl)-2,4,8,10-tetra-oxaspiro[5,5]undecane.

The content of the hindered phenol compound, the hindered amine compound or the sulfur-containing compound in the cellulose ester film is ordinarily from 0.001 to 10.0 parts by weight, preferably from 0.01 to 5.0 parts by weight, and more preferably 0.1 to 3.0 parts by weight, based on 100 parts by weight of cellulose ester.

(Cellulose Ester)

The cellulose ester in the invention is a single or mixed acid cellulose ester including in the cellulose ester structure at least one of an aliphatic acyl group or a substituted or unsubstituted aromatic acyl group.

Examples of the benzene ring substituent group when the aromatic ring in the aromatic acyl group is a benzene ring include, a halogen atom, a cyano group, an alkyl group, a cycloalkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R)(—O—R), —P(—O—R)₂, —PH(═O)—R—P(═O)(—R)₂, —PH(═O)—O—R, —P(═O)(—R)(—O—R), —P(═O)(—O—R)₂, —O—PH(═O)—R, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted)carbamoyl and N-methyl carbamoyl. The number of carbon atoms in the sulfamoyl group is preferably no greater than 20, and more preferably no greater than 12. Examples of the sulfamoyl group include (unsubstituted)sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of the invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaroyl, hexanoyl, octanoyl, lauroyl, stearoyl and the like.

The aliphatic acyl group in the invention also refers to one which is further substituted, and examples of the substituent include those which when the aromatic ring in the aromatic acyl group described above is a benzene ring, are denoted in the substituents of the benzene ring.

When the ester group of cellulose ester has an aromatic ring, the number of the substituent groups X on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycylic ring (such as naphthalene, indene, indane, phenanthrene, quinoline, isoquinoline, chromene, chromane, phthalazine, acridine, indole, indoline and the like).

In the invention, the cellulose ester has in the ester group a structure selected from at least one of a substituted or unsubstituted aliphatic acyl group or a substituted or unsubstituted aromatic acyl group, and this may be a single acid cellulose ester or a mixed acid cellulose ester, and two or more types of cellulose esters may be used in combination.

The cellulose ester used in the invention is preferably at least one type selected from cellulose acetate, cellulose propionate, cellulose butyrate, cellulose acetate propionate, cellulose acetate butyrate, cellulose acetate phthalate and cellulose phthalate.

The lower aliphatic acid esters such as cellulose acetate propionate and cellulose acetate butyrate, which are preferred as the mixed aliphatic acid cellulose ester, have an acyl group having 2 to 4 carbon atoms as the substituent.

In the invention, cellulose acetate propionate and cellulose acetate butyrate, which satisfy both Equation (1) and Equation (2) below, are preferred.
2.6≦X+Y≦3.0 Equation (1)
0≦X≦2.5 Equation (2)
wherein X represents a degree of substitution of the acetyl group; and Y represents a degree of substitution of the propionyl group or the butyryl group.

Cellulose acetate propionate is preferably used herein, and of the cellulose acetate propionates, those that satisfy 1.9≦X≦2.5 and 0.1≦Y≦0.9 are particularly preferable. The portion of the acyl group that is not substituted is usually a hydroxyl group. These may be synthesized by a known method.

In the cellulose ester used in the invention, the ratio of the weight average molecular weight Mw/number average molecular weight Mn is preferably 1.5-5.5, while 2.0-5.0 is particularly preferable, 2.5-5.0 is more preferable and 3.0-5.0 is even more preferable.

The cellulose which is the raw material for the cellulose ester of the invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100, 80:10:10, 85:0:15, and 40:30:30.

(Plasticizer)

The cellulose ester film of the invention preferably contains a plasticizer.

Addition of compounds generally known as plasticizers to film is preferred in view of modifying the film since it improves functional properties, imparts flexibility and resistance to water absorption, and reduces water transmittance. Also, in the melt cast method in the invention, the plasticizer is added to reduce melting temperature of the materials constituting cellulose ester film to be lower than the glass transition temperature of cellulose ester used. Also, at the same temperature, the viscosity of the materials constituting the film including the plasticizer can be reduced to be less than that of the cellulose ester. In the invention, the melting temperature of the materials constituting the film refers to temperature at which the materials become liquid.

In cellulose ester by itself, fluidity of the cellulose is not exhibited at a temperature less than its glass transition temperature since film is formed. However, at a temperature higher than the glass transition temperature, the modulus of elasticity or the viscosity is reduced due to absorption of heat, and the fluidity is exhibited. In order to melt the materials constituting the film, a plasticizer to be added is preferred which has a melting point or glass transition temperature that is lower than the glass transition temperature of the cellulose ester in fulfilling the above-cited objective. Further, an ester plasticizer is preferred which is formed from polyhydric alcohol and a monocarboxylic acid or from a polycarboxylic acid and a monohydric alcohol have high affinity to the cellulose ester.

In the invention, an ester plasticizer formed from a polyhydric alcohol and a monocarboxylic acid is preferably used.

Examples of an ethylene glycol ester based plasticizer, which is one of polyhydric alcohol ester based plasticizers, include ethylene glycol alkyl ester based plasticizers such as ethylene glycol acetate, ethylene glycol butyrate and the like; ethylene glycol dicycloalkyl ester based plasticizers such as ethylene glycol dicyclopropyl carboxylate, and ethylene glycol dicyclohexyl carboxylate; and ethylene glycol aryl ester based plasticizers such as ethylene glycol dibenzoate, and ethylene glycol di-4-methyl benzoate. These alkylate groups, cycloalkylate groups and arylate groups may be the same or different and may further be substituted. The substituent groups may be a mix of alkylate groups, cycloalkylate groups and arylate groups, and the substituent groups may be bonded to each other by covalent linkage. The ethylene glycol portions may be substituted. Further, a part of the ethylene glycol ester structure may be part of a polymer or may be systematically included in a polymer side chain as a pendant. It may also be introduced into a part of the molecular structure of additives such as an antioxidant, an acid scavenger, and an ultraviolet absorbent.

Examples of a glycerin ester based plasticizer, which is one of a polyhydric alcohol ester based plasticizers, include glycerin alky esters such as triaceetin, tributylin, glycerin diacetate carboxylate, and glycerin oleate propionate; glycerin cycloalkyl esters such as glycerin tricyclopropyl carboxylate, and glycerin tricyclohexyl carboxylate; glycerin aryl esters such as glycerin tribenzoate, and glycerin 4-methylbenzoate; diglycerin alkyl esters such as diglycerin tetraacetylate, diglycerin tetrapropionate, digylcerin acetate tricarboxylate, and diglycerin tetralaurate; diglycerin cycloalkyl esters such as diglycerin tetracylobutyl carboxylate, and diglycerin tetracylopentyl carboxylate; and diglycerin aryl esters such as diglycerin tetrabenzoate, and diglycerin 3-methyl benzoate. These alkylate groups, cycloalkyl carboxylate groups and arylate groups may be same or different and may further be substituted. The substituent groups may be a mixture of the alkylate groups, cycloalkyl carboxylate groups and arylate groups, and the substituent groups may be bonded to each other by common bonds. Further, the glycerin and diglycerin portions may be substituted. Further, a part of the glycerin and diglycerin ester structure may be part of a polymer or may be systematically included in a polymer side chain as a pendant. It may also be introduced into a part of the molecular structure of additives such as an antioxidant, an acid scavenger, and an ultraviolet absorbent.

Examples of other polyhydric alcohol ester based plasticizers are given in JP-A 2003-12823 from paragraphs 30-33.

Of the ester based plasticizers formed from a polyhydric alcohol and a monocarboxylic acid, alkyl polyhydric alcohol aryl esters are preferable, and examples thereof include ethylene glycol benzoate, glycerin tribenzoate, diglycerin tetrabenzoate and exemplified compound 16, which is given as an example in paragraph 32 of JP-A 2003-12823.

(Other Plasticizers)

Other plasticizers that can be also used in the invention include phosphoric acid ester plasticizers, polymer plasticizers and the like.

Examples of the phosphoric acid ester plasticizer include phosphoric acid alkyl esters such as triacetyl phosphate, tributyl phosphate and the like, phosphoric acid cycloalkyl esters such as tricyclopentyl phosphate, cyclohexyl phosphate and the like, phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphtyl phosphate, triglyceryl phosphate, tris ortho-biphenyl phosphate. The substituent groups for these may be the same or different, and may be further substituted. The substituent groups may be a mix of alkyl groups, cycloalkyl groups and aryl groups, and the substituent groups may be bonded to each other by common bonds.

Examples of the phosphoric acid ester also include alkylene bis(dialkyl phosphates) such as ethylene bis(dimethyl phosphate), butylene bis(diethyl phosphate) and the like, alkylene bis(diaryl phosphates such as ethylene bis(diphenyl phosphate),propylene bis(dinaphtyl phosphate) and the like, arylene bis(dialkyl phosphates) such as phenylene bis(dibutyl phosphate), biphenylene bis(dioctyl phosphate) and the like, arylene bis(diaryl phosphates) such as phenylene bis(diphenyl phosphate), naphtylene bis(ditriyl phosphate) and the like. These substituent groups may the same or different, and may be further substituted. The substituent groups may be a mix of an alkyl group, cycloalkyl groups and aryl groups, and the substituent groups may be bonded to each other by common bonds.

Further, a part of the phosphoric acid ester structure may be part of a polymer or may be systematically included in a polymer side chain as a pendant. It may also be introduced into a part of the molecular structure of additives such as an antioxidant, an acid scavenger, and an ultraviolet absorbent. Of the compounds listed above, aryl ester phosphates and arylene bis(diaryl phosphates) are preferable, and more specifically, triphenyl phosphate and phenylene bis(diphenyl phosphate) are preferable.

Examples of the polymer plasticizer include acrylic polymers such as an aliphatic hydrocarbon polymer, an alicyclic hydrocarbon polymer, polyacrylate ether, methyl polymethacrylate and the like, vinyl polymers such as polyvinyl isobutyl ether, poly N-vinyl pyrrolidone and the like, styrene polymers such as polystyrene, poly 4-hydroxy styrene and the like, polyesters such as polybutylene succinate, polyethylene terephthalate, polyethylene naphthalate and the like, polyethers such as polyethylene oxide, polypropylene oxide and the like, polyamides, polyurethanes, polyurea and the like. The number average molecular weight is preferably about 1,000-500,000 and 5,000-20,000 is particularly preferable. If the number average molecular weight is less than 1,000 there are problems with respect to volatility, while if it exceeds 500,000 the plasticizing properties decrease and the mechanical properties of the cellulose ester derivative composition are adversely affected. The polymer plasticizer may be a homopolymer formed by repeating the same kind of polymer units, or may be a copolymer having a structure in which there is a plurality of repeated units. In addition, two or more kinds of the polymers may be used together.

The added amount of the plasticizers in the cellulose ester film is ordinarily from 0.1 to 50 parts by weight, preferably from 1 to 30 parts by weight, and more preferably from 3 to 15 parts by weight, based on 100 parts by weight of cellulose ester.

(Radical Trapping Agent)

In the degradation process of polymers, there are various processes including 1) generation of carbon radicals due to bond cleavage, 2) generation of peroxy radicals due to reaction of carbon radicals and oxygen, and 3) withdrawal of hydrogens by peroxy radicals. Various degradation processes occur according to the kinds of activated species. In order to prevent the degradation of polymers, additives, which inactivate the activated species produced, are necessary.

(Carbon Radical Trapping Agent)

The cellulose ester film of the invention preferably contains a carbon radical trapping agent. A carbon radical trapping agent is effective in order to trap carbon radicals generated in the process above 1) quickly and inactivate the radicals. The carbon radical trapping agent herein refers a compound having a group (such as a group having a double bond or a triple bond) capable of quickly addition-reacting with carbon radicals generated by bond cleavage and providing a stable compound which does not cause any reaction (such as polymerization) after addition reaction.

As carbon radical trapping agents, there are a compound having in the molecule a group (for example, an unsaturated group such as (meth)acryloyl group or allyl group) quickly reacting with carbon radicals and a phenol compound or lactone compound having radical polymerization inhibition function.

The carbon radical trapping agent in the invention is preferably a compound represented by the following formula 5 or 6.

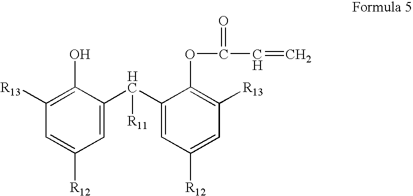

In formula 5, R₁₁ represents a hydrogen atom or an alkyl group having a carbon atom number of from 1 to 10, preferably a hydrogen atom or an alkyl group having a carbon atom number of from 1 to 4, and more preferably a hydrogen atom or a methyl group; R₁₂ and R₁₃ independently represent an alkyl group having a carbon atom number of from 1 to 8, provided that the alkyl may be straight-chained, branched or cyclic. R₁₂ and R₁₃ are preferably a quaternary carbon atom containing group represented by the following formula,
*—C(CH₃)₂—R′
wherein * represents the site bonding the aromatic (benzene) ring and R′ represents an alkyl group having a carbon atom number of from 1 to 5.

R₁₂ is preferably a tert-butyl group, a tert-amyl group, or a tert-octyl group. R₁₃ is preferably a tert-butyl group, or a tert-amyl group.

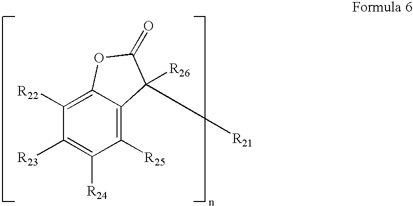

In formula 6, R₂₂ through R₂₅ independently represent a hydrogen atom or a substituent; R₂₆ represents a hydrogen atom or a substituent; n is 1 or 2, provided that when n is 1, R₂₁ represents a monovalent substituent, and when n is 2, R₂₁ represents a divalent linkage group.

Examples of the substituent represented by formula R₂₂ through R₂₅ include an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoylamino group), an alkylthio group (for example, a methylthio group, or an ethylthio group), an arylthio group (for example, a phenylthio group or a naphthylthio group), an alkenyl group (for example, a vinyl group, 2-propenyl group, a 3-butenyl group, a 1-methyl-3-propenyl group, a 3-pentenyl group, a 1-methyl-3-butenyl group, a hexenyl group or a cyclohexenyl group), a halogen atom (for example, fluorine, chlorine, bromine, iodine), an alkinyl group (for example, a propargyl group), a heterocyclic group (for example, pyridyl group, a thiazolyl group, an oxazolyl group or an imidazolyl group), an alkylsulfonyl group (for example, a methylsulfonyl group or an ethylsulfonyl group), an arylsulfonyl group (for example, a phenylsulfonyl group or a naphthylsulfonyl group), a sulfinyl group (for example, a methylsulfinyl group), an arylsulfonyl group (a phenylsulfinyl group), a phosphono group, an acyl group (for example, an acetyl group, a pivaloyl group or a benzoyl group), a carbamoyl group (for example, an aminocarbonyl group, a methylaminocarbonyl group, a dimethylaminocarbonyl group, a butylaminocarbonyl group, a cyclohexylaminocarbonyl group, a phenylaminocarbonyl group, or a 2-pyridylaminocarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group), a sulfonamide group (for example, a methanesulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycleoxy group, a silyloxy group, an acyloxy group (for example, an acetyloxy group, or a benzoyloxy group), a sulfonic acid group, a sulfonate group, an aminocarbonyloxy group, an amino group (for example, an amino group, an ethylamino group, a dimethylamino group, a butylaminocarbonyl group, a cyclopentylamino group, a 2-ethylhexylamino group, or a dodecylamino group), an anilino group (for example, a phenylammino group, a chlorophenylammino group, a toluidino group, an anisidino group, a naphthylamino group or a 2-pyridylamino group), an imino group, a ureido group (for example, a methylureido group, an ethylureido group, a pentylureido group, a cyclohexylureido group, an octylureido group, a dodecylureido group, a phenylureido group, a naphthylureido group, or a 2-pyridylureido group), an alkoxycarbonylamino group (for example, a methoxycarbonylamino group or a phenoxycarbonylamino group), an alkoxycarbonyl group (for example, a methoxycarbonyl group or an ethoxycarbonyl group), an aryloxycarbonyl group (for example, a phenoxycarbonyl group), a heterocyclicthio group, a thioureido group, a carboxyl group, a carboxylate group, a hydroxyl group, a mercapto group, and a nitro group. These substituents may further have the substituent as described above.

The substituent represented by R₂₆ is the same as those denoted in R₂₂ through R₂₅ above. When n is 1, the monovalent substituent represented by R₂₁ is the same as the substituents denoted in R₂₂ through R₂₅ above. When n is 2, the linkage group represented by R₂₁ represents a substituted or unsubstituted alkylene group, a substituted or unsubstituted arylene group, an oxygen atom, a nitrogen atom, a sulfur atom or a combination thereof.

In formula 6, n is preferably 1.

Typical examples of compounds represented by formula 5 include “Sumilizser GM” (trade name), “Sumilizser GS” (trade name), each being available from Sumitomo Kagaku Kogyo Co., Ltd.

Examples of the compound represented by formula 5 will be listed below, but the invention is not limited thereto.

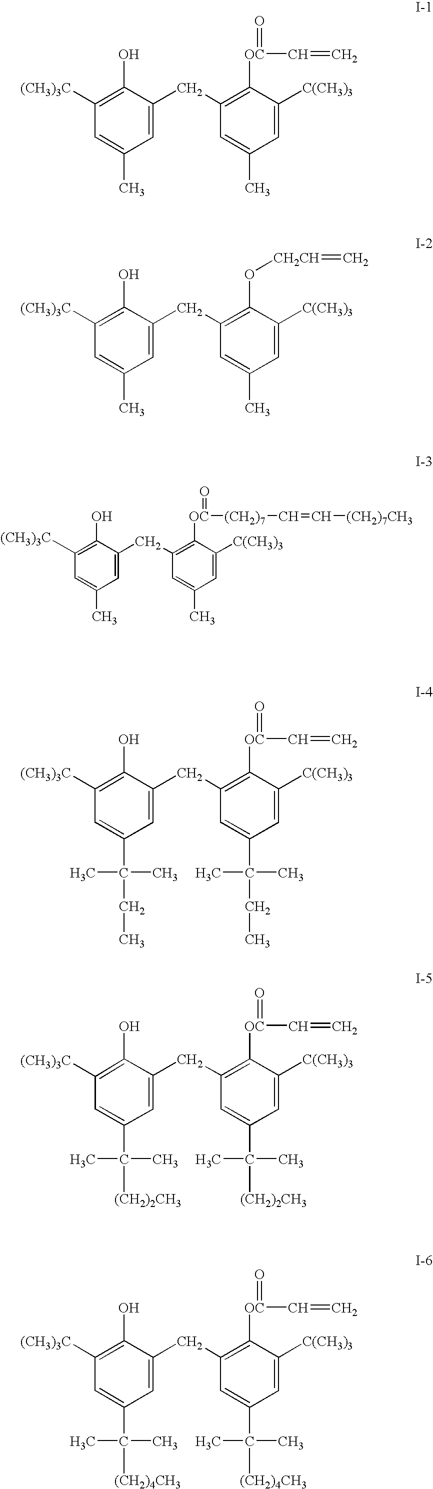

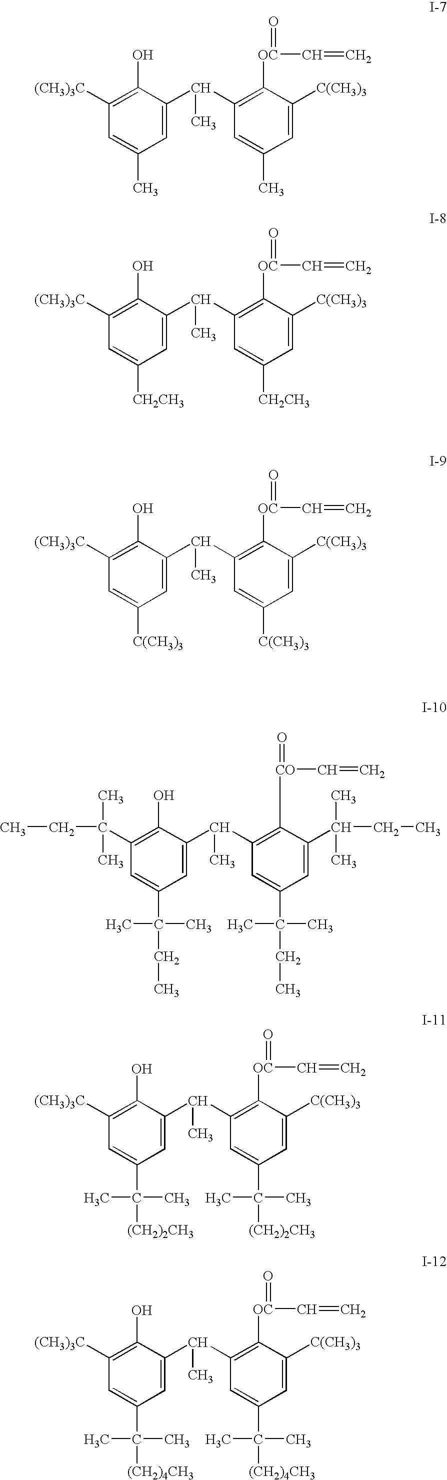

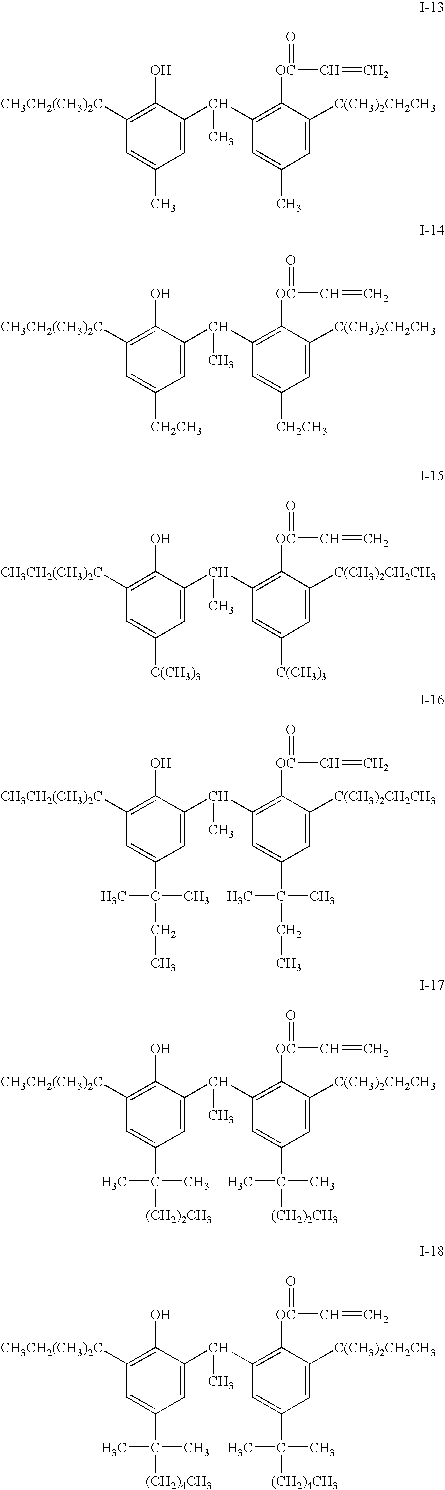

Examples of the compound represented by formula 6 will be listed below, but the invention is not limited thereto.

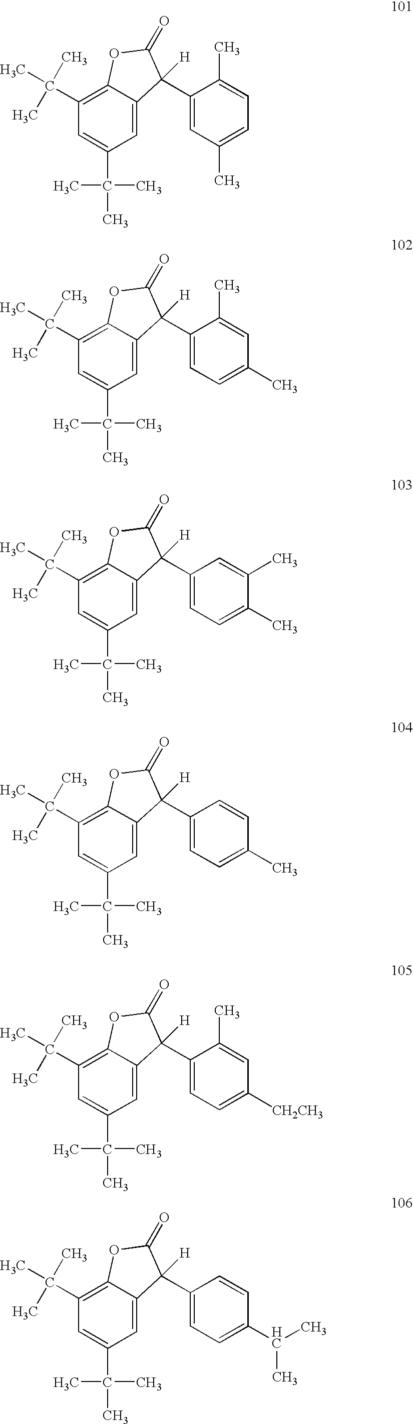

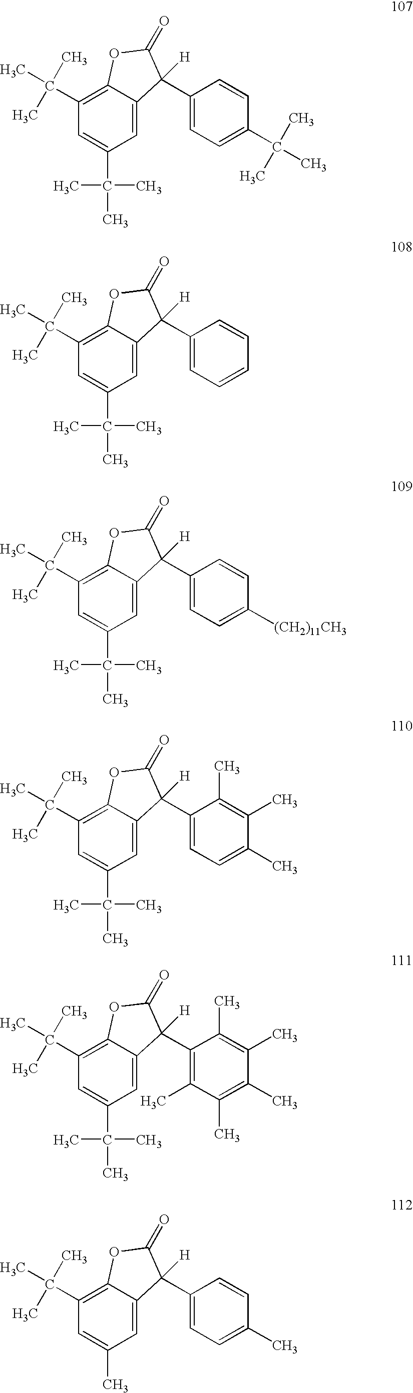

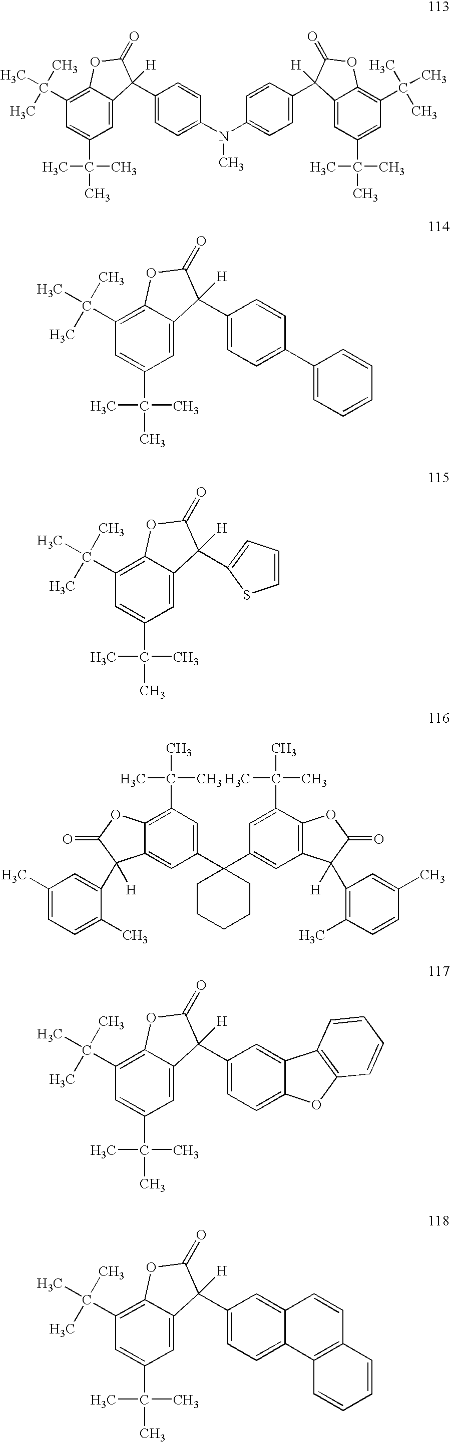

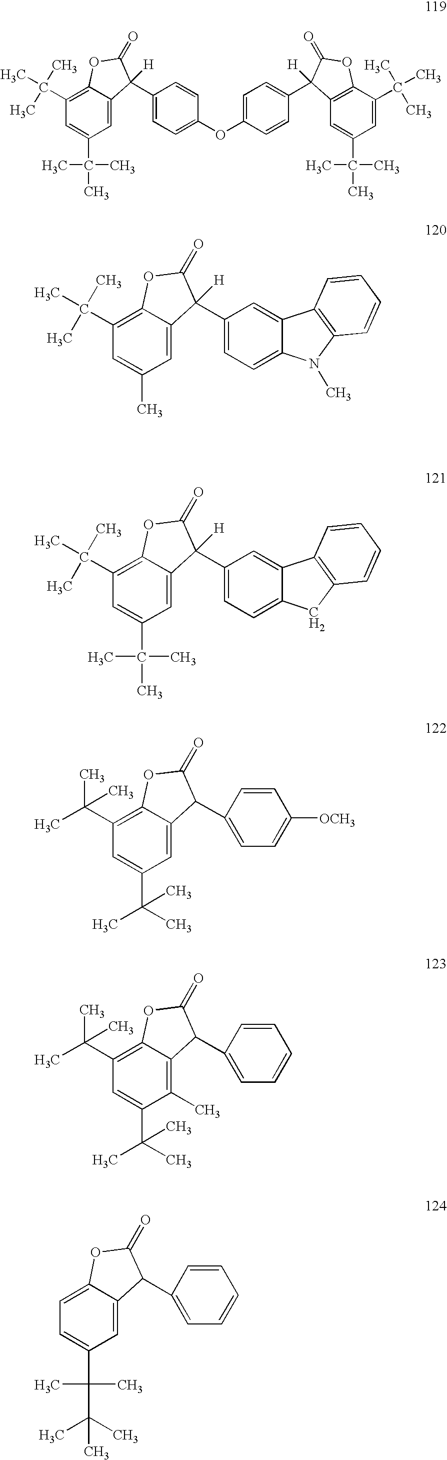

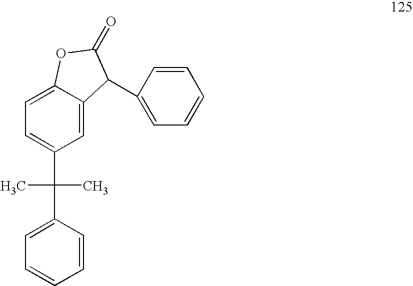

These carbon radical trapping agents can be used singly or as an admixture of two or more kinds thereof. The carbon radical trapping agent content of the light sensitive layer is preferably from 0.001 to 10.0 parts by weight and more preferably from 0.01 to 5.0 parts by weight, and still more preferably from 0.1 to 3.0 parts by weight, base on the weight of cellulose ester used.

(Additives)

In addition to the compounds described above, the cellulose ester film of the invention can contain additives such as a peroxide decomposing agent, a metal inactivating agent, an ultraviolet absorbent, a matting agent, a dye or pigment.

Additives can be used in the cellulose ester film which restrains generation of volatiles due to decomposition or deterioration of the film such as coloration or molecular weight reduction, and provides functions such as water-vapor permeability and lubricity, including anti-oxidation, trap of oxygen occurring due to decomposition or restraining of decomposition due to radicals generated on light exposure or heating or due to unknown causes in cellulose ester.

(Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Examples thereof include epoxy compounds, which are acid trapping agents described in U.S. Pat. No. 4,137,201. The epoxy compounds which are trapping agents include those known in the technological field, and examples include polyglycols derived by condensation such as diglycidyl ethers of various polygycols, especially those having approximately 8-40 moles of ethylene oxide per mole of polyglycol, diglycidyl ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxidized natural glycerides or unsaturated fatty acids and these fatty acids generally have 12 to 22 carbon atoms)). Particularly preferable are commercially available epoxy resin compounds, which include an epoxy group such as EPON 815c, and other epoxidized ether oligomer condensates such as those represented by the general formula 4.

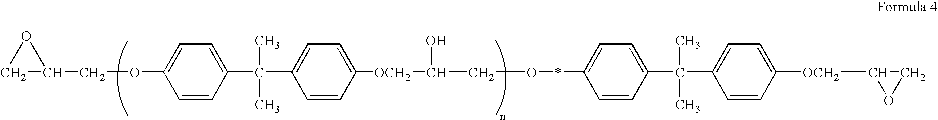

In the formula n is an integer of 0-12. Other examples of acid trapping agents that can be used include those described in paragraphs 87-105 in JP-A 5-194788.

(Ultraviolet Absorbent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet absorbents include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the ultraviolet absorbents described in JP-A Nos. 10-182621 and 8-337574, and the high molecular weight ultraviolet absorbents described in JP-A 6-148430 may also be used.

Examples of the benzotriazole based ultraviolet absorbents include 2-(2′-hydroxy-5′-methylphenyl)benzotriazole, 2-(2′-hydroxy 3′,5′-di-tert-butyl phenyl)benzotriazole, 2-(2′-hydroxy 3′-tert-butyl-5′-methylphenyl)benzotriazole, 2-(2′-hydroxy 3′,5′-di-tert-butyl phenyl)-5-chlorobenzotriazole, 2-(2′-hydroxy 3′-(3″,4″,5″,6″-tetrahydrophthalimide methyl)-5′-methylphenyl)benzotriazole, 2,2-methyl bis(4-(1,1,3,3,-tetramethyl butyl)-6-(2H-benzotriazole-2-yl)phenyl), 2-(2′-hydroxy-3′-tert-butyl-5′-methylphenyl)-5-chlorobenzotriazole, 2-(2H-benzotriazole-2-yl)-6-(straight chain or side chain dodecyl)-4-methylphenyl, and mixtures of octyl-3-[3-tert-butyl-4-hydroxy-5-(chloro-2H-benzotriazole-2-yl)phenyl] propionate and 2-ethylhexyl-3-[3-tert-butyl-4-hydroxy-5-(5-chloro-2H-benzotriazole-2-yl)phenyl] propionate. The benzotriazole based ultraviolet absorbent is however, not limited to these examples.

In the invention, a conventional ultraviolet absorbing polymer can be used in combination. The conventional ultraviolet absorbing polymer is not specifically limited, but there is, for example, a homopolymer obtained by polymerization of LUVA-93 (produced by Otuka Kagaku Co., Ltd.) and a copolymer obtained by copolymerization of LUVA-93 and another monomer. Typical examples of the ultraviolet absorbing polymer include PUVA-30M obtained by copolymerization RUVA 93 and methyl methacrylate (3:7 by weight ratio), PUVA-50M obtained by copolymerization RUVA 93 and methyl methacrylate (5:5 by weight ratio), and ultraviolet absorbing polymers disclosed in Japanese Patent O.P.I. Publication No. 2003-113317.

Commercially available TINUVIN 109, TINUVIN 171, TINUVIN 900 and TINUVIN 928 (each being manufactured by Chiba Specialty Chemical Co., Ltd.), LA-31 (manufactured by Asahi Denka Co., Ltd.), LUVA-100 (produced by Otuka Kagaku Co., Ltd.) and Sumisorb 250 (produced by Sumitomo Kagaku Co., Ltd.) may also be used.

Examples of the benzophenone based compound include 2,4-hydroxy benzophenone, 2,2′-dihydroxy-4-methoxy benzophenone, 2-hydroxy-4-methoxy-5-sulfobenzophenone, bis(2-methoxy-4-hydroxy-5-benzoyl phenyl methane) and the like, but are not limited thereto.

The added amount of the ultraviolet absorbent in the cellulose ester film is preferably from 0.1 to 20% by weight, more preferably from 0.5 to 10% by weight, and still more preferably from 1 to 5% by weight. Two or more kinds of the ultraviolet absorbent may be used together.

(Matting Agent)

Fine particles such as a matting agent or the like may be added to the cellulose ester film of the invention in order to impart a matting effect, and fine particles of inorganic compounds as well as fine particles of organic compounds may be used. The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of high molecular weigh polymers of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halogens, alkoxysilanes, silazanes, and siloxanes. Particles having a larger average particle diameter have a greater matting effect, while particles having a smaller average particle diameter have excellent transparency. The secondary particles have an average particle diameter in the range of 0.05 to 1.0 μm. The secondary particles preferably have an average particle diameter in the range of 5 to 50 nm, and more preferably 7 to 14 nm. These fine particles are preferable because they create unevenness of 0.01 to 1.0 μm in the plane of the cellulose ester film. The amount of the fine particles included in the cellulose ester is preferably 0.005 to 0.3% by weight.

Examples of the silicon dioxide particles include Aerosil 200, 20V, 300, R972, R972V, R974, R202, R812, OX50, or TT600 each manufactured by Nippon Aerosil Co., Ltd., and of these, Aerosil 200V, R972, R972V, R974, R202, and R812, are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1:99.9-99.9:0.1

The presence of the fine particles used as the matting agent in the film can also serve another purpose of improving the strength of the film. The presence of the fine particles in the film may also improve the orientation of the cellulose ester itself, which constitutes the polarizing plate protective film of this invention.

(Birefringence Adjusting Agent)

A liquid crystal layer is provided on the orientation film formed on the cellulose ester film of the invention to prepare an optical film with an optical compensation function, which is derived from a combination of the film and the liquid crystal layer with birefringence. A polarizing plate used in a liquid crystal display may be modified employing such an optical film in order to improve display quality of the liquid crystal display. Aromatic compounds having two or more aromatic rings disclosed in European Patent No. 911,656 A2 can be used as a birefringence adjusting agent. Two or more kinds of the aromatic compounds may be used. The aromatic ring of the aromatic compound is an aromatic hydrocarbon ring or an aromatic heterocyclic ring. The aromatic heterocyclic ring is preferred. The aromatic heterocyclic ring is generally an unsaturated heterocyclic ring. Compounds having a 1,3,5-triazine ring are especially preferred.

(Polymers)

Polymers or oligomers other than cellulose ester may be incorporated in the cellulose ester film of the invention. The polymers or oligomers are preferably those having excellent compatibility with the cellulose ester. Transmittance of the cellulose ester film of the invention is preferably not less than 80%, more preferably not less than 90%, and still more preferably not less than 92%. Cellulose ester in which at least one of the polymers and the oligomers is incorporated has advantages that its melt viscosity can be adjusted and physical properties of the film formed from the cellulose ester are improved.

(Inclusion Method of Components)

In the invention, inclusion of the components in the invention in the cellulose ester film does not only refer to the components being enclosed by the cellulose ester, but also refers to the components being present on both the inside and the outer surface of the cellulose ester.

The inclusion methods of the components include one in which the cellulose ester is dissolved in a solvent, and then the components are dissolved or dispersed in the resultant solution, and then the solvent is removed. Known methods are used to remove the solvent, and examples thereof include the liquid drying method, the air drying method, the solvent co-precipitation method, the freeze-drying method, and the solution casting method. The resulting mixture of the cellulose ester and the components after the removal of the solvent can be prepared so as be in the form of fine particles, granules, pellets, a film or the like. The above inclusion of the components is performed by dissolving a solid cellulose ester as described above, but this dissolution may be performed at the same time when precipitation of cellulose ester is carried out in synthesizing the cellulose ester.

An example of the liquid drying method is one in which an aqueous solution of an activating agent such as sodium lauryl sulfate is added to a solution in which the cellulose ester and the acid are dissolved and an emulsion and dispersion is performed. Next, the solvent is removed by normal pressure or low pressure distillation, and a dispersant of the cellulose ester having the components included therein is thereby obtained. In addition, centrifugal separation or decantation is preferably performed in order to remove the active agent. Various methods may be used as the emulsification method, and emulsification device using supersonic waves, high-speed rotational shearing and high pressure may be used.

In the emulsification and dispersion method using ultrasonic waves, a so-called batch method and continuous method may be used. The batch method is suitable for preparation of comparatively small amounts of sample, while the continuous method is suitable for large amounts of sample. In the continuous method, a device such as the UH-600SR (manufactured by SMT Co., Ltd.) may be used. In the case of the continuous method, the amount of time for the irradiation of the supersonic waves can be determined by the capacity of the dispersion chamber/flow rate x circulation frequency. In the case where there is more than one supersonic irradiation device, the total of each irradiation time is determined. The irradiation time for the supersonic waves is no more than 10,000 seconds. Also, if the irradiation time needs to be greater than 10,000 seconds, the processing load becomes large, and the actual emulsion dispersion time must be made shorted be re-selecting the emulsifying agent or the like. As a result, a time exceeding 10,000 seconds is not necessary. It is more preferable that the time is between 10 and 2,000 seconds.

A disperser mixer, a homogenizer, an ultra mixer or the like may be used as the emulsion and dispersion device which uses high-speed rotational shearing, and the viscosity of the liquid at the time of emulsion and dispersion can determine which type of device is used.

For emulsion and dispersion using high pressure, LAB 2000 (manufactured by SMT Co., Ltd.) may be used, but the emulsion and dispersion capability depends on the pressure that is applied to the sample. Pressure in the range of 10⁴-5×105 kPa is preferable.

Examples of the active agent that may be used include a cation surface active agent, an anion surface active agent, an amphoteric surface active agent and a high molecular weight polymer dispersing agent. The active agent used is determined by the solvent and the particle diameter of the target emulsion.

The air drying method is one in which a spray dryer such as GS310 (manufactured by Yamato Scientific Co., Ltd.) is used, and a solution in which the cellulose ester and the components are dissolved is sprayed.

The solvent co-precipitation method is one in which a solution in which the cellulose ester and the components are dissolved is added to a poor solvent of the cellulose ester and the components, whereby precipitation takes place. The poor solvent is freely miscible with the solvent which dissolves the cellulose ester. The poor solvent may also be a mixed solvent. The poor solvent may also be added to a solution of the cellulose and the components.

A mixture of the cellulose ester and the components precipitated is filtered, and dried.

In the mixture of the cellulose ester and the precipitated, the particle diameter of the components is no greater than 1 μm and preferably no greater than 500 nm, and still more preferably no greater than 200 nm. The smaller the particle size of the components, the more even the distribution of the mechanical strength and the optical properties of the melt cast, and thus a small particle size is favorable.

It is preferable that the mixture of the cellulose ester and the components as well as additives added during heat melting are dried prior to or during heat melting. Drying herein refers to removing moisture adsorbed by any of the cellulose ester and components, as well as water or solvent used during preparing the mixture of the cellulose ester and components or solvents introduced during synthesizing additives.

The removal method may be any known drying method, and examples include the heating method, the pressure reduction method, the heating and pressure reduction method and the like, and may be performed in the air or in an inert gas environment with nitrogen selected as the inert gas. In view of film quality, it is preferable that these known drying methods are performed in a temperature range where the materials do not decompose.

For example, the amount of moisture or solvent remaining after removal in the drying step is no greater than 10 weight %, preferably no greater than 5 weight %, more preferably no greater than 1 weight %, and still more preferably no greater than 0.1 weight %, based on the total weight of materials constituting the film. The drying temperature at this time is preferably between 100° C. and the Tg of the material to be dried. In view of preventing the materials from adhering to each other the drying temperature is preferably between 100° C. and the (Tg-5)° C. and more preferably between 110° C. and the (Tg-20)° C. The drying time is preferably 0.5-24 hours, and more preferably 1-18 hours and still more preferably 1.5-12 hours. If the drying time is less than these ranges, the level of drying will be low or the drying will take too much time. Also, if the material to be dried has a Tg, if it is heated to a drying temperature that is higher than Tg, the material melts and handling is difficult.

The drying stage may be separated into 2 or more stages. For example the melt film may be prepared via storage of the material using a preliminary drying step and a pre-drying step which is performed directly before to one week before the melt layer is prepared.

(Cellulose Ester Film)

The cellulose ester film of the invention has a thickness of preferably from 10 to 500 μm. The thickness of the cellulose ester film of the invention is preferably not less than 20 μm, and more preferably not less than 35 μm. The thickness of the cellulose ester film of the invention is preferably not more than 150 μm, and more preferably not more than 150 μm. The thickness of the cellulose ester film of the invention is especially preferably from 25 to 90 μm. Haze of the cellulose ester film of the invention is preferably less than 1%, and more preferably less than 0.5%.

(Manufacturing Process of Cellulose Ester)

The cellulose ester film of the invention is preferably manufactured according to a melt cast method. The melt cast method refers to a method which comprises the steps of heat-melting cellulose ester without using a solvent at temperature exhibiting its fluidity to obtain a fluid cellulose ester and then casting the fluid cellulose ester on a support. Methods for the heat-melting can be classified into a melt extrusion molding method, a press molding method, an inflation method, an ejection molding method, a blow molding method, and an stretch molding method. Of these, the melt extrusion method is excellent in obtaining a cellulose ester film with excellent mechanical strength and excellent surface accuracy. As the manufacturing process of the cellulose ester film of the invention, there is, for example, a method which comprises the steps of heat-melting a cellulose ester composition constituting the cellulose ester film at temperature exhibiting its fluidity to melt and then extruding and casting the melted composition on a support such as a drum or an endless belt to form a web.

The cellulose ester composition in the invention, being subjected to melt extrusion, is extruded as a film from a T-type die to be in contact with a cooling drum using an electrostatic discharge method, and cooled to obtain an unstretched film. The temperature of the cooling drum is preferably maintained at 90 to 150° C.

The melt extrusion may be performed using a uniaxial extruder, a biaxial extruder, or using a biaxial extruder which has a uniaxial extruder connected downstream thereof, but it is preferable that the uniaxial extruder is used in view of the mechanical strength and optical properties of the resulting film. Also, it is preferable that the usual ambient air supplied to the raw material tank, the raw material charge section and the extruder interior and during the melting process is replaced by an inactive gas such as nitrogen, or that the pressure of the ambient air is reduced.

The temperature during melt extrusion is ordinarily in the range of 150 to 300° C., preferably 180 to 270° C., and still more preferably 200 to 250° C.

The cellulose ester film of the invention is preferably stretched in the transverse direction or in the mechanical direction.

The film is preferably peeled from the cooling drum and the resulting unstretched film is heated in the range from the glass transition temperature (Tg) of the cellulose ester to Tg+100° C. via a heating device, such as a plurality of heated rollers and/or infrared ray heaters, and stretched in one step or multiple-steps in the mechanical direction, and cooled. Next, the resulting cellulose ester film, which has been stretched in the mechanical direction as described above, is preferably also stretched in the transverse direction in the range of Tg to Tg-20° C., after which heat-fixing is preferably conducted.

During transverse stretching, when the stretching is done while sequentially heating the film in two or more stretching zones which have a temperature difference of 1-50° C., distribution of physical properties in the transverse direction of the film is reduced, which is favorable. Also, when the film after transverse stretching is maintained for 0.01 to 5 minutes between the final transverse stretching temperature and Tg-40° C., the distribution of physical properties in the transverse direction of the film is further reduced, which is advantageous.

Heat-fixing is normally done within a range higher than the final lateral stretching temperature but not greater than Tg-20° C. for a period of 0.5-300 seconds. At that time, it is preferable that heat-fixing is done while sequentially elevating temperature in two or more stretching zones which have a temperature difference in the range of 1 to 100° C.

The film subjected to heat-fixing is usually cooled to a temperature not more than Tg, and the clip holding portion of both ends of the film is cut off and the film is wound up. At that time, it is preferred that a 0.1 to 10% relaxing process is performed in the transverse and/or mechanical direction at a temperature range between the final heat-fixing temperature and Tg-20(° C.). Also, gradual cooling is preferably conducted in such a manner that cooling from the final heat-fixing temperature to the Tg is achieved at a cooling rate not greater than 100° C. per second. The means for the slow cooling or relaxing process is not particularly limited and can be performed by common known means, but it is particularly preferable to perform these processes while sequentially cooling in a plurality of temperature zones in view of improving dimensional stability of the film. It is to be noted that, given that the final fixing temperature is Tl and the time for the film to reach Tg from the final heat-fixing temperature is “t”, the cooling rate is determined by (Tl−Tg)/t.

The optimal conditions for heat-fixing, cooling, and slow cooling processes differ depending on cellulose ester constituting the film, and thus are determined by measuring the physical properties of the biaxially stretched film, and suitably adjusting the conditions to obtain favorable properties.

(Functional Layers)

In the invention, functional layers such as an antistatic layer, a hard coat layer, an anti-reflection layer, a matting facilitating layer, a contact facilitating layer, an anti-glare layer, a barrier layer, an optical compensation layer, or the like may be provided on the cellulose ester film prior to and/or after stretching. It is preferred that at least one layer selected from the anti-static layer, the hard coat layer, the anti-reflection layer, the contact facilitating layer, the anti-glare layer and the optical compensation layer is provided. At that time, various surface treatments such corona discharge treatment, plasma treatment, chemical treatment and the like may also be carried out, as appropriate.

In addition, after the clip holding portion of both ends of the film, that have been cut off, are subjected to a grinding process or granulation process as appropriate, it may be reused as material for the same or a different film.

A composition containing cellulose resins, and additives such as the plasticizer, ultraviolet absorbents described above having a different concentration may be co-extruded to prepare a layered structure cellulose ester film. For example, a cellulose ester film can be made so as to have the structure of a skin layer/a core layer/a skin layer. A matting agent may be contained in a larger amount in the skin layers or alternatively, may be only in the skin layers. The plasticizer and the ultraviolet light absorber may be contained in a larger amount in the core layer than in the skin layers, or may be only in the core layer. The types of plasticizers and ultraviolet absorbents in the core layer and the skin may be changed and a low volatile plasticizer and/or an ultraviolet absorbent may be added to the skin layer, while a plasticizer with excellent plasticity or an ultraviolet absorbent with excellent ultraviolet absorption may be added to the core layer. Tg of the skin layer and the core layer may be different, and it is preferred that the Tg of the core layer is lower than that of a skin layer. Further, the viscosity of melt including the cellulose ester during melt casting may differ between the skin layer and the core layer, and the viscosity of the skin layer may be greater than the core layer, or the viscosity of the core layer may be greater than or equal to the skin layer.

(Polarizing Plate)

The cellulose ester film of the invention can be used as a polarizing plate protective film. When the cellulose ester film of the invention is used as a polarizing plate protective film, a preparing method of the polarizing plate is not specifically limited and can be carried out employing a conventional method. The polarizing plate protecting film is alkali treated, and is laminated through a completely saponified polyvinyl alcohol on both sides of a polarized film, which is obtained by immersing a polyvinyl alcohol film in an iodine solution and stretching. This method is advantageous in that the polarizing plate protecting film can be directly laminated at least one surface of a polarized film.

Lamination processing disclosed in Japanese Patent O.P.I. Publication Nos. 6-94915 and 6-118232 can be applied instead of the alkali treatment to manufacture a polarizing plate.

The polarizing plate is comprised of a polarized film and a polarizing plate protecting film provided on both surfaces of the polarizing plate. The polarizing plate may have further a protect film on one surface, and a separate film on the other surface. The protect film or separate film is provided in order to protect the surface of the polarizing plate at shipment or transportation. The protect film is provided on the surface of the polarizing plate opposite the polarizing plate surface to be adhered to a liquid crystal cell. The separate film is used in order to cover an adhesive layer through which the polarizing plate is adhered to the liquid crystal cell, and provided on the polarizing plate surface to which the liquid crystal cell is adhered.

(Dimensional Stability)

In the cellulose ester film of the invention, variation of the film dimension is preferably within the range of ±1.0%, more preferably within the range of ±0.5%, and still more preferably within the range of ±0.1%, after the film has been allowed to stand at 80° C. and at 90% RH for 24 hours, based on the film dimension after the film has been allowed to stand at 23° C. and at 55% RH for 24 hours.

(Stretching and Refractive Index Control)

Refractive index of the cellulose ester film of the invention can be controlled by stretching appropriately. When the stretching is performed by a factor of 1.0 to 2.0 in one direction of the cellulose ester film and by a factor of 1.01 to 2.5 in the direction in plane of the film perpendicular to that direction, the refractive index can be controlled within a desirable range.

For example, the film can be successively or simultaneously stretched in the mechanical direction and in the direction (transverse direction) in plane normal to the mechanical direction. In this case, too small stretching magnification in at least one direction provides insufficient optical retardation, while too much stretching magnification results in rupture of the film.

For example, when film is stretched in the casting direction, too much contraction in the transverse direction of the film provides too large refractive index in the thickness direction of the film. In this case, improvement can be carried out by restraining the contraction in the transverse direction of the film or by stretching the film in the transverse direction.

When the film is stretched in the transverse direction, diversion of refractive index may be produced in the transverse direction. This phenomenon is sometimes found in a tenter method, and is considered to be due to so-called bowing phenomenon, which is caused by the fact that the film center shrinks and the film edges are fixed. In this case also, the bowing phenomenon is restrained by stretching the film in the casting direction, whereby diversion of refractive index in the transverse direction is minimized and improved.

Further, stretching in the two directions crossing at right angles each other can minimize variation of film thickness. Too much variation of film thickness causes unevenness of the optical retardation, resulting in color unevenness of images of a liquid crystal display.

Variation of thickness of cellulose ester film is preferably in the range within preferably ±3%, and more preferably ±1%. In order to meet the requirements described above, stretching in the two directions crossing at right angles each other is effective, wherein finally, the film is stretched in the casting direction by a magnification of preferably from 1.0 to 2.0, and more preferably from 1.01 to 1.5, and in the transverse direction by a magnification of preferably from 1.01 to 2.5, and more preferably from 1.2 to 2.0.

When cellulose ester providing a positive birefringence to stress is employed, stretching in the transverse direction can give the delayed phase axis to the transverse direction of cellulose ester film. In order to improve display quality, the delayed phase axis is preferably in accordance with the transverse direction of film, and it is necessary to meet the relationship (stretching magnification in the transverse direction)>(stretching magnification in the casting direction).

The coefficient of variation (CV) of retardation in plane R₀ (defined later) of an optical film is preferably less than 5%, more preferably not more than 2%, and still more preferably less than 1.5%. The CV of retardation Rₜ in the thickness direction (defined later) of an optical film is preferably less than 5%, more preferably not more than 2%, and still more preferably less than 1.5%. In the phase difference film, variation of retardation is preferably less. When a polarizing plate comprising the phase difference film is used in a liquid crystal display, the phase difference film having less variation of retardation is preferred in minimizing color unevenness. In order to adjust retardation of a phase difference film to improve a displaying quality of a VA mode or TN mode liquid crystal cell, so that the phase difference film is employed in a MVA mode which is divided into multi-domains as the VA mode, R₀ is preferably from more than 30 to 95 nm, and Rₜ is preferably from more than 70 nm to 400 nm.

The web stretching method is not specifically limited. As the stretching method, there are a method stretching film in the mechanical direction employing plural rollers having a different circumferential speed, a method stretching film in the mechanical direction by pulling clips or pins fixing the film edges in the mechanical direction, a method stretching film in the transverse direction by pulling clips or pins fixing the film edges in the transverse direction, and a method stretching film in the transverse direction and at the same time shrinking the film in the mechanical direction by pulling simultaneously clips or pins fixing the film edges in the mechanical and transverse directions. These methods may be used in combination. In a tenter method, when the clips are driven by a linear drive method, smooth stretching of film can be conducted, overcoming problems such as rupture of film.

In the film manufacture, holding of the film width or stretching in the transverse direction may be carried out employing a tenter, and the tenter may be a pin tenter or a clip tenter.

When the cellulose ester film of the invention is used as a polarizing plate protecting film, the thickness of the polarizing plate protecting film is preferably from 10 to 500 μm, more preferably from 20 to 150 μm, still more preferably from 35 to 120 μm, and most preferably from 25 to 90 μm. The above range of the thickness is preferred in weight reduction of a liquid crystal display, development of birefringence, and moisture resistance.

When a delayed or advanced phase axis of cellulose ester film is present in a plane of the film and the angle between the delayed or advanced phase axis and the mechanical direction of the film is defined as θ1, θ1 is preferably from −1 to +1°, and more preferably from −0.5 to +0.50°. This θ1 can be defined as an orientation angle, and determined employing an automatic birefringence meter KOBRA-21ADH (produced by Oji Keisoku Kiki Co., Ltd.).

The above range of 01 provides high luminance, minimized light leakage, and high color reproduction of displayed images in a color liquid crystal display.

(Liquid Crystal Display)

A liquid crystal display usually comprises two polarizing plates and provided therebetween, a liquid crystal cell. When the cellulose ester film of the invention is used as a polarizing plate protective film, the polarizing plate protective film provides excellent display properties regardless of where it is disposed. It is especially preferred that the polarizing plate protective film is provided on the outermost surface of the display side of the liquid crystal display.

When a polarizing plate protective film with an optical compensation film or a polarizing plate protective film manufactured employing stretching treatment to have a suitable optical compensation function is provided on the side of a liquid crystal cell, excellent displaying property is obtained. The cellulose ester film of the invention provides an optical film such a polarizing plate protective film, anti-reflection film or phase difference film with high quality. The cellulose ester film of the invention is used in various displays such as a liquid crystal display, a plasma display, and an organic EL display, and particularly in a liquid crystal display. The cellulose ester film of the invention is used as a polarizing plate protective film, a phase difference film, an anti-reflection film, a luminance increasing film, or a viewing angle increasing film.

### EXAMPLES

Next, the present invention will be explained employing examples, but is not limited thereto. The term, “parts” represents “parts by weight”, unless otherwise specified.

### Example 1

(Preparation of Cellulose Ester Film Samples)

Materials as shown in Tables 1 and 2 were mixed for 5 minutes in a tumbler mixer, and the mixture was extruded at a dies temperature of 230° C. through an extruder with a diameter of 20 mm to obtain strands. The resulting strands were cooled with water, and cut to prepare pellets. The pellet preparation process was repeated four times. The pellets prepared at the first process (a pellet preparation process number 1) and at the fourth processes (a pellet preparation process number 4) were heat-melted at a melting temperature of 240° C., extruded from a T die, and then stretched at a stretching ratio of 1.2×1.2 at 160° C. Thus, cellulose ester film samples having a thickness of 80 μm were obtained.

Materials used will be shown below.

(Cellulose Esters)

The following cellulose esters were prepared according to a conventional method.
CE-1: Cellulose acetate propionate with a degree of substitution of an acetyl group of 2.1 and a degree of substitution of a propionyl group of 0.7 (a total degree of substitution of an acyl group of 2.8), a weight average molecular weight of 210000 (in terms of polystyrene), and Mw/Mn of 2.6, in which Mw and Mn represent a weight average molecular weight and a number average molecular weight, respectively.
CE-2: Cellulose acetate propionate with a degree of substitution of an acetyl group of 1.5 and a degree of substitution of a propionyl group of 1.4 (a total degree of substitution of an acyl group of 2.9), a weight average molecular weight of 210000 (in terms of polystyrene), and Mw/Mn of 2.8
CE-3: Cellulose acetate propionate with a degree of substitution of an acetyl group of 0.1 and a degree of substitution of a propionyl group of 2.8 (a total degree of substitution of an acyl group of 2.9), a weight average molecular weight of 280000 (in terms of polystyrene), and Mw/Mn of 2.8
   (Phosphites)
E-1: 6-[3-(3-tert-Butyl-4-hydroxy-5-methylphenyl)propoxy]-2,4,8,10-tetrakis-tert-butyldibenzo[d,f][1.3.2]-dioxaphosphepin
E-2: 6-[3-(3,5-di-tert-Butyl-4-hydroxyphenyl)-propoxy]-2,4,8,10-tetrakis-tert-butyldibenzo[d,f][1.3.2]-dioxaphosphepin
   (Hindered Phenols)
P-1: n-Octadecyl 2-(3,5-di-t-butyl-4-hydroxyphenyl)acetate
P-2: Octadecyl 3-(3,5-di-tert-butyl-4-hydroxyphenyl)propionate
P-3: Triethylene glycol-bis(3-(3-t-butyl-4-hydroxy-5-methylphenyl)propionate)
P-4: Tetrakis[methylene-3-(3′,5′-di-t-butyl-4′-hydroxyphenylpropionate)]methane
   (Hindered Amines)
A-1: Bis(2,2,6,6-tetramethyl-4-piperidyl)sebacate
A-2: 2,2,6,6-Tetramethyl-4-piperidyl methacrylate
A-3: 4-[3-(3,5-di-tert-Butyl-4-hydroxyphenyl)propionyloxy]-1-[2-(3-(3,5-di-tert-butyl-4-hydroxyphenyl)propionyloxy)-ethyl]-2,2,6,6-tetramethylpiperidine
   (S-containing Compounds)
S-1: Dilauryl 3,3-thiodipropionate
S-2: Pentaerythritol-tetrakis(β-lauryl-thiopropionate)

(Plasticizers)

| | |
|---|---|
| | K-1 |
| 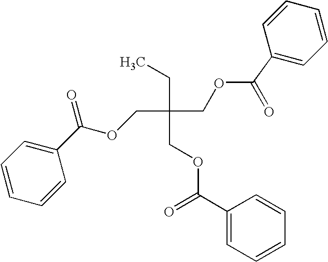 | |
| 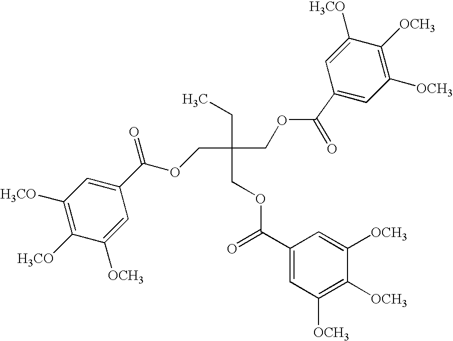 | K-2 |

| Sam- | Cellu- | Pellet | Phos- | Phos- | Hindered | Hindered | S-containing | Ester | |
|---|---|---|---|---|---|---|---|---|---|
| ple | lose | Preparation | phonite | phite | Phenol | Amine | Compound | Plasticizer | Re- |
| No. | Ester | Process No. | Kinds (*) | Kinds (*) | Kinds (*) | Kinds (*) | Kinds (*) | Kinds (*) | marks |
| 1 | CE-1 | 1 | | | | | | | Comp. |
| 2 | ″ | 4 | | | | | | | Comp. |
| 3 | ″ | 1 | PN-1 (0.5) | | | | | K-1 (10) | Inv. |
| 4 | ″ | 4 | PN-1 (0.5) | | | | | K-1 (10) | Inv. |
| 5 | ″ | 1 | PN-2 (0.5) | | P-1 (0.5) | | | K-1 (10) | Inv. |
| 6 | ″ | 4 | PN-2 (0.5) | | P-1 (0.5) | | | K-1 (10) | Inv. |
| 7 | ″ | 1 | PN-5 (0.2) | PP-1 (1) | | A-1 (0.25) | | K-1 (10) | Inv. |
| 8 | ″ | 4 | PN-5 (0.2) | PP-1 (1) | | A-1 (0.25) | | K-1 (10) | Inv. |
| 9 | ″ | 1 | PN-7 (0.15) | | P-2 (1) | | | K-1 (10) | Inv. |
| 10 | ″ | 4 | PN-7 (0.15) | | P-2 (1) | | | K-1 (10) | Inv. |
| 11 | ″ | 1 | PN-11 (0.15) | | | A-2 (0.5) | | K-1 (10) | Inv. |
| 12 | ″ | 4 | PN-11 (0.15) | | | A-2 (0.5) | | K-1 (10) | Inv. |
| 13 | ″ | 1 | PN-14 (0.15) | PP-1 (1) | | | S-1 (1) | K-1 (10) | Inv. |
| 14 | ″ | 4 | PN-14 (0.15) | PP-1 (1) | | | S-1 (1) | K-1 (10) | Inv. |
| 15 | ″ | 1 | PN-1 (0.2) | PP-1 (1) | | A-3 (1) | | K-2 (15) | Inv. |
| 16 | ″ | 4 | PN-1 (0.2) | PP-1 (1) | | A-3 (1) | | K-2 (15) | Inv. |
| 17 | ″ | 1 | PN-1 (0.05) | P-2 (1.5) | P-3 (1) | A-3 (1) | S-2 (0.05) | K-2 (15) | Inv. |
| 18 | ″ | 4 | PN-1 (0.05) | P-2 (1.5) | P-3 (1) | A-3 (1) | S-2 (0.05) | K-2 (15) | Inv. |
| 19 | ″ | 1 | PN-2 (0.2) | PP-1 (2) | P-3 (0.5) | | | K-2 (15) | Inv. |
| 20 | ″ | 4 | PN-2 (0.2) | PP-1 (2) | P-3 (0.5) | | | K-2 (15) | Inv. |
| 21 | ″ | 1 | PN-15 (0.2) | PP-1 (2) | P-3 (0.5) | | | K-2 (15) | Inv. |
| 22 | ″ | 4 | PN-15 (0.2) | PP-1 (2) | P-3 (0.5) | | | K-2 (15) | Inv. |
| 23 | ″ | 1 | PN-18 (0.2) | PP-1 (1) | P-3 (0.5) | | | K-2 (15) | Inv. |
| 24 | ″ | 4 | PN-18 (0.2) | PP-1 (1) | P-3 (0.5) | | | K-2 (15) | Inv. |

Comp.: Comparative, Inv.: Inventive
“*” The numerical values in the parentheses represent parts by weight based on 100 parts by weight of cellulose ester used.

TABLE 2

| | | Pellet | | | Hindered | Hindered | S-containing | Ester | |
|---|---|---|---|---|---|---|---|---|---|
| Sample | Cellulose | Preparation | Phosphonite | Phosphite | Phenol | Amine | Compound | Plasticizer | |
| No. | Ester | Process No. | Kinds (*) | Kinds (*) | Kinds (*) | Kinds (*) | Kinds (*) | Kinds (*) | Remarks |
| 25 | CE-1 | 1 | | PP-1 (1) | | | | | Comp. |
| 26 | ″ | 4 | | PP-1 (1) | | | | | Comp. |
| 27 | ″ | 1 | | PP-1 (1) | P-3 (2) | | | K-2 (10) | Comp. |
| 28 | ″ | 4 | | PP-1 (1) | P-3 (2) | | | K-2 (10) | Comp. |
| 29 | ″ | 1 | PN-22 (0.1) | PP-2 (2) | | A-3 (0.2) | | K-1 (10) | Inv. |
| 30 | ″ | 4 | PN-22 (0.1) | PP-2 (2) | | A-3 (0.2) | | K-1 (10) | Inv. |
| 31 | ″ | 1 | PN-29 (0.1) | PP-2 (2) | P-3 (1) | | | K-1 (10) | Inv. |
| 32 | ″ | 4 | PN-29 (0.1) | PP-2 (2) | P-3 (1) | | | K-1 (10) | Inv. |
| 33 | CE-2 | 1 | | | | A-2 (0.5) | | K-1 (10) | Comp. |
| 34 | ″ | 4 | | | | A-2 (0.5) | | K-1 (10) | Comp. |
| 35 | ″ | 1 | PN-1 (0.1) | PP-1 (0.5) | P-4 (1) | | | K-1 (10) | Inv. |
| 36 | ″ | 4 | PN-1 (0.1) | PP-1 (0.5) | P-4 (1) | | | K-1 (10) | Inv. |
| 37 | ″ | 1 | PN-4 (0.1) | PP-1 (0.5) | | A-3 (1) | | K-1 (10) | Inv. |
| 38 | ″ | 4 | PN-4 (0.1) | PP-1 (0.5) | | A-3 (1) | | K-1 (10) | Inv. |
| 39 | CE-3 | 1 | PN-6 (0.1) | PP-2 (1) | | | | K-1 (10) | Inv. |
| 40 | ″ | 4 | PN-6 (0.1) | PP-2 (1) | | | | K-1 (10) | Inv. |
| 41 | ″ | 1 | | | | | | K-1 (10) | Comp. |
| 42 | ″ | 4 | | | | | | K-1 (10) | Comp. |
| 43 | ″ | 1 | PN-1 (0.5) | PP-1 (3) | | A-3 (0.2) | | K-1 (15) | Inv. |
| 44 | ″ | 4 | PN-1 (0.5) | PP-1 (3) | | A-3 (0.2) | | K-1 (15) | Inv. |
| 45 | ″ | 1 | PN-10 (0.25) | PP-1 (3) | P-2 (0.3) | | S-1 (1) | K-1 (15) | Inv. |
| 46 | ″ | 4 | PN-10 (0.25) | PP-1 (3) | P-2 (0.3) | | S-1 (1) | K-1 (15) | Inv. |
| 47 | ″ | 1 | EN-13 (0.25) | PP-2 (2) | | | | K-1 (15) | Inv. |
| 48 | ″ | 4 | PN-13 (0.25) | PP-2 (2) | | | | K-1 (15) | Inv. |
| 49 | ″ | 1 | PN-24 (0.25) | PP-2 (1) | | A-2 (0.5) | | K-1 (15) | Inv. |
| 50 | ″ | 4 | PN-24 (0.25) | PP-2 (1) | | A-2 (0.5) | | K-1 (15) | Inv. |

Comp.: Comparative, Inv.: Inventive
(*) The numerical values in the parentheses represent parts by weight based on 100 parts by weight of cellulose ester used.

(Evaluation of Cellulose Ester Film Samples)

The resulting cellulose ester film samples were evaluated as follows.

(1) Smoking

Smoke generated from the outlet of a T die and the longitudinal polishing roll surface were visually observed, and evaluated according to the following criteria:
A: No smoking was observed.
B: Slight smoking was observed.
A: Marked smoking was observed.
A: Marked smoking was observed, and the longitudinal polishing roll surface became cloudy due to the smoking.
   (2) Processing Stability

Melt index (MI) is defined as a value obtained by representing, in terms of weight (g), the amount of a melted organic polymer composition flowing out from a circular die with a specific length and inner diameter at a specific temperature and a specific pressure, and used as a measure of melt index. In cellulose ester, the larger the value is, the better the processing stability. Further, the cellulose ester, in which variation of MI's measured repeatedly is small, is considered to exhibit high MI retention and high processing stability. Melt index (MI) of the pellets prepared at the first and fourth processes was measured at a temperature of 230° C. and at a pressure of 21.2N.

(3) Coloration

When an organic polymer into which additives are incorporated is evaluated, yellowness index (YI) is widely used as a measure of coloration. Yellowness index (YI) is measured employing a color meter. The larger the yellow index is, the larger the coloration. The smaller the yellow index is, the less the coloration, and a polymer with a small yellow index is an excellent polymer minimizing coloration during processing.

Yellowness index (YI) of cellulose ester film samples prepared employing the pellets prepared at the first and fourth processes was measured according to JIS K7103, and the difference between them was determined.

(4) Coefficient of Variation (CV) of Retardation

Refractive index in three directions of the cellulose ester film samples prepared employing the pellets prepared at the first process was measured at an interval of 1 cm in the transverse direction of the samples. The measurement was carried out at a wavelength 590 nm at 23° C. and 55% RH employing an automatic birefringence meter KOBRA-21ADH (produced by Oji Keisokuki Co., Ltd.). From the resulting measurements, retardations were obtained employing the following formulae (a) and (b), and then coefficient of variation (CV) of retardation was determined.
Retardation in plane R₀=(nx−ny)×d Formula (a)
Retardation in the thickness direction Rt={(nx+ny)/2−nz}×d Formula (b)
wherein d represents a thickness (nm) of the sample, nx represents a maximum refractive index in plane of the sample (a refractive index in the delayed phase axis direction in plane of the sample), ny represents a refractive index in the direction normal to the delayed phase axis direction in plane of the sample, and nz represents a refractive index in the thickness direction of the sample. Standard deviation of the resulting retardation in plane and retardation in thickness direction was determined according to a (n−1) method. Subsequently, a coefficient of variation of the retardation in plane and in the thickness direction was determined by the following formula. Herein, n was set as 130-140.
Coefficient of variation (CV) of retardation (in plane and retardation in thickness direction)=Standard deviation of retardation/Average of retardation

The resulting CV of retardation was evaluated according to the following criteria.
A: CV is less than 1.5%, which is practically excellent.
B: CV is in the range of from 1.5% to less than 5%, which is practically at lowest permissible level.
C: CV is in the range of from 5% to less than 10%, which is practically problematic.
D: CV is not less than 10%, which cannot be put into practical use.
   (5) Transparency Haze of the cellulose ester film samples prepared employing the pellets prepared at the first process was determined employing a haze meter 1001DP TYPE (produced by Nippon Denshoku Co., Ltd.), and the samples were evaluated according to the following criteria:
A: Haze is less than 0.5%.
B: Haze is in the range of from 0.5% to less than 1.0%.
C: Haze is in the range of from 1.0% to less than 1.5%.
D: Haze is in the range of from 1.5% to less than 2.0%.
E: Haze is not less than 2.0%.

The results are shown in Table 3.

TABLE 3

| | | | Yellow- | Coefficient | | |
|---|---|---|---|---|---|---|
| | | Melt | ness | of variation | | |
| Sample | | index | index | (CV) of | Trans- | Re- |
| No. | Smoking | (MI) | (YI) | retardation | parency | marks |
| 1 | C | 2.5 | 6.8 | D | E | Comp. |
| 2 | C | 0.5 | 12.5 | | | Comp. |
| 3 | A | 4.0 | 3.5 | B | B | Inv. |
| 4 | B | 3.5 | 4.5 | | | Inv. |
| 5 | A | 3.7 | 3.6 | B | B | Inv. |
| 6 | B | 3.3 | 4.5 | | | Inv. |
| 7 | A | 3.8 | 3.3 | A | A | Inv. |
| 8 | B | 3.7 | 3.4 | | | Inv. |
| 9 | A | 3.6 | 3.5 | B | B | Inv. |
| 10 | B | 3.4 | 3.6 | | | Inv. |
| 11 | A | 3.4 | 3.7 | B | B | Inv. |
| 12 | B | 3.2 | 3.8 | | | Inv. |
| 13 | A | 3.4 | 3.3 | A | A | Inv. |
| 14 | B | 3.2 | 3.4 | | | Inv. |
| 15 | A | 3.9 | 3.4 | A | A | Inv. |
| 16 | B | 3.8 | 3.5 | | | Inv. |
| 17 | A | 4.2 | 3.3 | A | A | Inv. |
| 18 | B | 4.0 | 3.4 | | | Inv. |
| 19 | A | 4.0 | 3.2 | A | A | Inv. |
| 20 | B | 3.9 | 3.3 | | | Inv. |
| 21 | A | 3.8 | 3.4 | A | A | Inv. |
| 22 | B | 3.6 | 3.6 | | | Inv. |
| 23 | A | 3.7 | 3.5 | A | A | Inv. |
| 24 | B | 3.5 | 3.7 | | | Inv. |
| 25 | D | 2.5 | 4.0 | D | E | Comp. |
| 26 | D | 0.5 | 10.5 | | | Comp. |
| 27 | D | 4.0 | 3.8 | C | C | Comp. |
| 28 | D | 1.5 | 9.9 | | | Comp. |
| 29 | A | 3.5 | 3.8 | A | A | Inv. |
| 30 | B | 3.3 | 4.0 | | | Inv. |
| 31 | A | 3.5 | 3.5 | A | A | Inv. |
| 32 | B | 3.4 | 3.6 | | | Inv. |
| 33 | D | 4.0 | 4.5 | D | D | Comp. |
| 34 | D | 2.2 | 11.0 | | | Comp. |
| 35 | A | 3.7 | 3.5 | A | A | Inv. |
| 36 | B | 3.5 | 3.5 | | | Inv. |
| 37 | A | 3.7 | 3.5 | A | A | Inv. |
| 38 | B | 3.5 | 3.7 | | | Inv. |
| 39 | A | 3.7 | 3.5 | A | A | Inv. |
| 40 | B | 3.5 | 3.6 | | | Inv. |
| 41 | C | 4.0 | 8.8 | D | D | Comp. |
| 42 | C | 0.5 | 15.5 | | | Comp. |
| 43 | A | 3.7 | 3.5 | A | A | Inv. |
| 44 | B | 3.5 | 3.6 | | | Inv. |
| 45 | A | 3.7 | 3.4 | A | A | Inv. |
| 46 | B | 3.6 | 3.5 | | | Inv. |
| 47 | A | 3.8 | 3.7 | A | A | Inv. |
| 48 | B | 3.5 | 3.9 | | | Inv. |
| 49 | A | 3.9 | 3.8 | A | A | Inv. |
| 50 | B | 3.6 | 4.0 | | | Inv. |

Comp.: Comparative, Inv.: Inventive

As is apparent from Table 3, the inventive samples provide excellent processing stability, minimized coloration, less variation of retardation and high transparency, as compared with the comparative samples. It has proved that the inventive samples have excellent optical properties.

### Example 2

(Preparation of Coating Liquids)

The following coating liquids were prepared.

(Antistatic Layer Coating Liquid 1)

| | | |
|---|---|---|
| Polymethyl methacrylate (weight average molecular weight: | 0.5 | parts |
| 550,000; Tg: 90° C.) | | |
| Propylene glycol monomethyl ether | 60 | parts |
| Methyl ethyl ketone | 16 | parts |
| Ethyl lactate | 5 | parts |
| Methanol | 8 | parts |
| Conductive polymer resin P-1 (particle size: 0.1-0.3 μm) | 0.5 | parts |

(Hard Coat Layer Coating Liquid 2)

| | |
|---|---|
| Dipentaerythritol hexacrylate monomer | 60 parts |
| Dipentaerythritol hexacrylate dimer | 20 parts |
| Dipentaerythritol hexacrylate oligomer (having three or more | 20 parts |
| of dipentaerythritol hexacrylate unit) | |
| Diethoxybenzophenone photoinitiator | 6 parts |
| Silicon-contained surface active agent | 1 part |
| Propylene glycol monomethyl ether | 75 parts |
| Methyl ethyl ketone | 75 parts |

(Anti-curl Layer Coating Liquid 3)

| | |
|---|---|
| Acetone | 35 parts |
| Ethyl acetate | 45 parts |
| Isopropyl alcohol | 5 parts |
| Diacetyl cellulose | 0.5 part |
| 2% superfine silica particle acetone dispersion (Aerosil | 0.1 part |
| 200V, manufactured by Nippon Aerosil Co., Ltd.) | |
| Conductive polymer resin P-1 | |
| 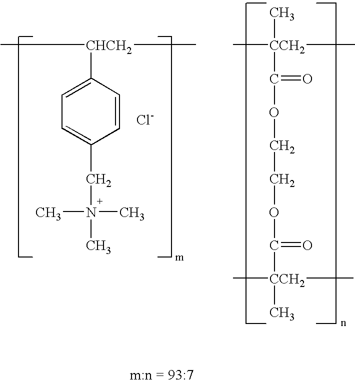 | |

Polarizing plate protective films were prepared according to the following.

Polarizing Plate Protective Film

On one surface of sample, which was prepared in the same manner as sample 3 of Example 1 except that the sample was stretched in the mechanical direction by a factor of 1.2 and in the transverse direction by a factor of 2.0, an anti-curl layer liquid 3 was applied using gravure coating so that the wet coating thickness was 13 μm, and then dried at a drying temperature of 80±5° C. to form an anti-curl layer. Thus, sample 53A was prepared.

The surface of the sample 53A opposite the anti-curl layer was coated with an antistatic layer liquid 1 at a 28° C. and 82% RH, at a film conveyance speed of 30 m/min, and at a coating width of 1 m so that the wet coating thickness was 7 μm, and then dried at the drying section which was set at 80±5° C. to form an anti-static layer with a dry coating thickness of 0.2 μm. Thus, sample 53B with an antistatic layer was prepared.

In addition, the hard coat layer coating liquid 2 was coated on the antistatic layer of sample 53B so that the wet thickness was 13 μm, then dried at a drying temperature of 90° C., and then subjected to ultraviolet ray irradiation at 150 mJ/m² to form a clear hard coat layer with a dry thickness of 5 μm. Thus, sample 53C was prepared.

The resulting samples 53A, 53B and 53C had favorable coating properties without causing brushing and any cracks after drying.

Samples 55(A, B and C), 57(A, B and C), 59(A, B and C), 63(A, B and C), 65(A, B and C), 71(A, B and C), 79(A, B and C), 85(A, B and C), 89(A, B and C), 93(A, B and C) and 97(A, B and C) were prepared in the same manner as in samples 53(A, B and C) above, except that sample 3 was changed to samples 5, 7, 9, 13, 15, 21, 29, 35, 39, 43 and 47. The resulting samples had favorable coating properties.

For comparison, the same procedures as above were performed using optical film samples 1, 25, 33, and 41. Thus, samples 51A, 75A, 83A and 91A with the anti-curl layer applied were prepared, samples 51B, 75B, 83B and 91B with the antistatic layer applied were prepared, and samples 51C, 75C, 83C and 91C with the hard coat layer applied were prepared.

The results reveal that when coating was done in a high humidity environment, brushing occurred in 51A, 75A, 83A and 91A. Further, fine cracks after drying were sometimes observed in samples 51B, 75B, 83B and 91B, and fine cracks after drying were apparent in samples 51C, 75C, 83C and 91C.

(Preparation of Polarizing Plate)

A 120 μm thick polyvinyl alcohol film was immersed in an aqueous solution comprised of 1 part by weight of iodine, 2 parts by weight of potassium iodide and 4 parts by weight of boric acid, and stretched at 50° C. by a factor of 4 to obtain a polarized film.

Inventive samples 3, 5, 9, 13, 21, 27, 35,43 and 47, and comparative samples 1, 25, 27, and 41 were subjected to alkali treatment at 40° C. for 60 seconds in 2.5 M aqueous solution of sodium hydroxide, then washed in water, and dried, thereby the surface of the samples was subjected to alkali treatment.

The alkali treated surface of inventive samples 3, 5, 9, 13, 21, 27, 35,43 and 47, and comparative samples 1, 25, 27, and 41 was adhered to each side of the polarized film obtained above using a 5% completely saponified polyvinyl alcohol aqueous solution as an adhesive. Thus, inventive polarizing plate samples 3, 5, 9, 13, 21, 27, 35,43 and 47, and comparative polarizing plate samples 1, 25, 27, and 41, each having a polarizing plate protective film were prepared.

Inventive polarizing plate samples 3, 5, 9, 13, 21, 27, 35, 43 and 47 exhibited excellent polarization, and superior optical and physical properties, as compared to comparative polarizing plate samples 1, 25, 27, and 41.

(Liquid Crystal Display and its Evaluation)

The polarizing plate of a 15-inch TFT color liquid crystal display LA-1529HM (manufactured by NEC Corporation) was peeled off from both sides of the liquid crystal cell. Each of the polarizing plate samples prepared above was cut to fit the size of the liquid crystal cell, and adhered to both sides of the liquid crystal cell so that the polarizing axes of the two polarizing plate samples intersected at right angles without changing the original polarizing axes. Thus, a 15-inch TFT color liquid crystal display was prepared in which the polarizing plate was changed, and evaluated for display properties. As a result, the liquid crystal display, employing inventive polarizing plate samples, exhibited high image contrast and excellent display properties, as compared to those employing comparative polarizing plate samples. This has proved that the inventive polarizing plate samples are superior as a polarizing plate for an image display device such as a liquid crystal display.

### Example 3

(Preparation of Cellulose Ester Film Samples)

Materials as shown in Table 4 were mixed for 5 minutes in a tumbler mixer, and the mixture was extruded at a dies temperature of 230° C. through an extruder with a diameter of 20 mm to obtain strands. The resulting strands were cooled with water, and cut to prepare pellets. The pellets were heat-melted at a melting temperature of 240° C., extruded from a T die, and then stretched at a stretching ratio of 1.2×1.2 at 160° C. Thus, phase difference film samples having a thickness of 40 μm, a width of 2.2 m, an R₀ of from 45 to 55 nm, and an Rₜ of from 120 to 135 nm were obtained.

Materials used will be shown below, and others are the same as described above.

(Cellulose Esters)

CE-4: Cellulose acetate propionate with a degree of substitution of an acetyl group of 1.38 and a degree of substitution of a propionyl group of 1.30 (a total degree of substitution of an acyl group of 2.68), a weight average molecular weight of 210000 (in terms of polystyrene), and Mw/Mn of 2.9

CE-5: Cellulose acetate propionate with a degree of substitution of an acetyl group of 1.31 and a degree of substitution of a propionyl group of 1.23 (a total degree of substitution of an acyl group of 2.54), a weight average molecular weight of 200000 (in terms of polystyrene), and Mw/Mn of 2.9

TABLE 4
(Phosphite PP-3)

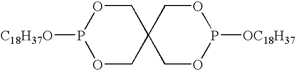

(Plasticizer)
K-3

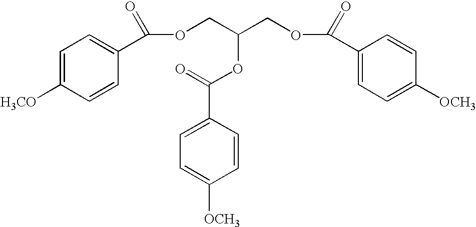

(Ultraviolet Absorbent)
UV-1:

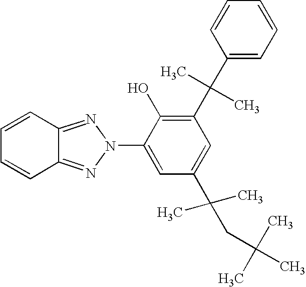

UV-2:

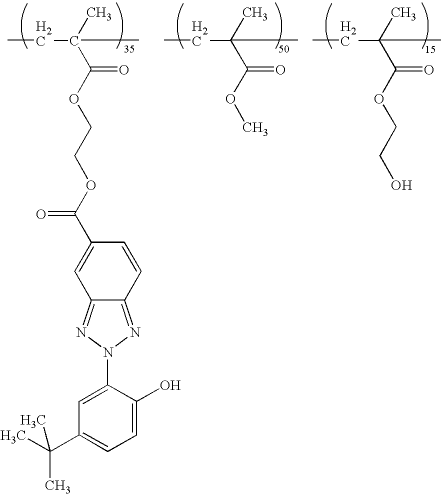

UV-3:

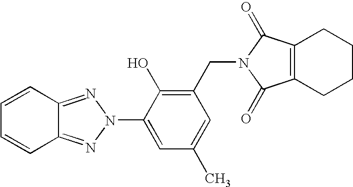

| Sam- | Cellu- | | | Hindered | Carbon Radical | Ester | Ultraviolet | |
|---|---|---|---|---|---|---|---|---|
| ple | lose | Phosphonite | Phosphite | Phenol | trapping Agent | Plasticizer | Absorbent | Re- |
| No. | Ester | Kinds (*) | Kinds (*) | Kinds (*) | Kinds (*) | Kinds (*) | Kinds (*) | marks |
| 51 | CE-1 | | | P-2 (0.5) | | K-1 (8) | | Comp. |
| 52 | CE-2 | | | P-2 (0.5) | I-16 (0.25) | K-1 (8) | | Comp. |
| 53 | CE-2 | | | P-4 (0.5) | 108 (0.25) | K-1 (8) | | Comp. |
| 54 | CE-3 | | PP-3 (0.25) | | I-16(0.25) | K-1 (8) | | Comp. |
| 55 | CE-1 | | PP-3 (0.25) | P-4 (0.5) | | K-1 (8) | | Comp. |
| 56 | CE-3 | | PP-3 (0.25) | P-4 (0.5) | I-16(0.25) | K-1 (8) | | Comp. |
| 57 | CE-1 | PN-1 (0.25) | | | 108 (0.25) | K-1 (8) | | Inv. |
| 58 | CE-1 | PN-1 (0.25) | | | I-16 (0.25) | K-1 (8) | | Inv. |
| 59 | CE-1 | PN-1 (0.25) | | | I-1 (0.25) | K-1 (8) | | Inv. |
| 60 | CE-1 | PN-2 (0.25) | | | I-1 (0.25) | K-1 (8) | | Inv. |
| 61 | CE-2 | PN-1 (0.25) | | P-4 (0.5) | | K-1 (8) | | Inv. |
| 62 | CE-2 | PN-2 (0.25) | | P-4 (0.5) | | K-1 (8) | | Inv. |
| 63 | CE-2 | PN-3 (0.25) | | P-4 (0.5) | | K-1 (8) | | Inv. |
| 64 | CE-2 | PN-5 (0.25) | | P-4 (0.5) | | K-1 (8) | | Inv. |
| 65 | CE-1 | PN-1 (0.25) | | P-4 (0.5) | I-16 (0.25) | K-2 (12) | | Inv. |
| 66 | CE-3 | PN-1 (0.25) | | P-4 (0.5) | I-16 (0.25) | K-1 (8) | | Inv. |
| 67 | CE-4 | PN-1 (0.25) | | P-4 (0.5) | I-16 (0.25) | K-2 (12) | | Inv. |
| 68 | CE-4 | PN-1 (0.25) | | P-4 (0.5) | I-16 (0.25) | K-1 (8) | UV-1 (1.5) | Inv. |
| 69 | CE-4 | PN-1 (0.25) | | P-4 (0.5) | 108 (0.25) | K-3 (10) | | Inv. |
| 70 | CE-4 | PN-1 (0.25) | | P-4 (0.5) | I-16 (0.25) | K-3 (10) | | Inv. |
| 71 | CE-4 | PN-1 (0.25) | | P-4 (0.5) | I-16 (0.25) | K-2 (12) | UV-3 (2.1) | Inv. |
| 72 | CE-5 | PN-1 (0.25) | | P-4 (0.5) | 108 (0.25) | K-2 (12) | | Inv. |
| 73 | CE-5 | PN-1 (0.25) | | P-4 (0.5) | 108 (0.25) | K-3 (10) | UV-3 (2.5) | Inv. |
| 74 | CE-5 | PN-1 (0.25) | | P-4 (0.5) | I-16 (0.25) | K-1 (8) | | Inv. |
| 75 | CE-5 | PN-2 (0.25) | | P-4 (0.5) | I-16 (0.25) | K-1 (8) | | Inv. |

Comp.: Comparative, Inv.: Inventive
“*” The numerical values inthe parentheses represent parts by weight based on 100 parts by weight of cellulose ester used.

(Evaluation of Phase Difference Film Samples)

The resulting samples were evaluated as follows.

(1) Processing Stability

Melt index (MI) of the pellets prepared above was measured at a temperature of 230° C. and at a pressure of 21.2N according to JIS-K7210.

(2) Coloration

Absorption spectra of the samples were measured through a spectrophotometer U-3310 (manufactured by Hitachi High Technology Co., Ltd.), and tristimulus values X, Y, and Z were determined. Yellowness index (YI) was measured from the tristimulus values X, Y, and Z according to JIS K7103. The resulting yellowness index (YI) was evaluated according to the following criteria:
A: Yellowness index (YI) is less 0.8
B: Yellowness index (YI) is from 0.8 to less than 1.0.
C: Yellowness index (YI) is from 1.0 to less than 1.5.
D: Yellowness index (YI) is from 1.5 to less than 2.0.
E: Yellowness index (YI) is from 2.0 to less than 3.0.
F: Yellowness index (YI) is from 3.0 to less than 4.0.
G: Yellowness index (YI) is not less than 4.0.
   (3) Coefficient of Variation (CV) of Retardation

CV of retardation in the thickness direction Rₜ of the film samples was determined in the same manner as in Example 1.

The resulting CV of Rₜ was evaluated according to the following criteria.
A: CV is less than 1.5%, which is practically absolutely excellent.
B: CV is in the range of from 1.5% to less than 2.0%, which is practically excellent.
C: CV is in the range of from 2.0% to less than 4.0%, which is practically good.
D: CV is in the range of from 4.0% to less than 5.0%, which is practically at lowest permissible level.
E: CV is in the range of from 5.0% to less than 8.0%, wherein a problem may be encountered in practical applications.
F: CV is in the range of from 8.0% to less than 10.0%, wherein a problem may be encountered in practical applications.
G: CV is not less than 10%, which cannot be put into practical use.
   (4) Transparency

Haze of the film samples prepared above was determined in terms of 80 μm, employing a haze meter 1001DP TYPE (produced by Nippon Denshoku Co., Ltd.), and the samples were evaluated according to the following criteria:
A: Haze is less than 0.5%.
B: Haze is in the range of from 0.5% to less than 1.0%.
C: Haze is in the range of from 1.0% to less than 1.5%.
D: Haze is in the range of from 1.5% to less than 2.0%.
E: Haze is not less than 2.0%.

The results are shown in Table 5.

TABLE 5

| | | Yellow- | Coefficient | | |
|---|---|---|---|---|---|
| | Melt | ness | of variation | | |
| Sample | index | index | (CV) of | Trans- | Re- |
| No. | (MI) | (YI) | retardation | parency | marks |
| 51 | 2.5 | G | G | E | Comp. |
| 52 | 2.6 | G | F | D | Comp. |
| 53 | 2.6 | F | F | D | Comp. |
| 54 | 2.5 | F | G | E | Comp. |
| 55 | 2.6 | F | F | D | Comp. |
| 56 | 2.7 | E | F | E | Comp. |
| 57 | 3.2 | D | D | B | Inv. |
| 58 | 3.1 | E | E | B | Inv. |
| 59 | 2.9 | E | E | B | Inv. |
| 60 | 2.8 | F | E | B | Inv. |
| 61 | 3.7 | C | C | A | Inv. |
| 62 | 3.0 | E | E | A | Inv. |
| 63 | 3.0 | E | E | A | Inv. |
| 64 | 3.5 | D | D | A | Inv. |
| 65 | 4.1 | B | B | B | Inv. |
| 66 | 4.1 | B | B | B | Inv. |
| 67 | 4.3 | B | A | A | Inv. |
| 68 | 4.3 | B | A | A | Inv. |
| 69 | 4.5 | A | A | A | Inv. |
| 70 | 4.3 | B | A | A | Inv. |
| 71 | 4.3 | B | A | A | Inv. |
| 72 | 4.5 | A | A | A | Inv. |
| 73 | 4.5 | A | A | A | Inv. |
| 74 | 4.3 | B | A | A | Inv. |
| 75 | 3.9 | C | C | A | Inv. |

Comp.: Comparative, Inv.: Inventive

As is apparent from Table 5, the inventive samples provide exellent processing stability, minimized coloration, less variation of retardation and high transparency, as compared with the comparative samples. It has proved that the inventive samples have excellent optical properties as a phase difference film. Particularly, inventive samples, comprising a phosphonite compound, a hindered phenol compound and a specific carbon radical trapping agent having a specific structure, provided greatly improved results.

What is claimed is:

1. A cellulose ester film comprising cellulose ester and a phosphonite compound.

2. The cellulose ester film of claim 1, wherein the phosphonite compound is represented by the following formula 1 or 2,
R₁P(OR₂)₂ Formula 1
wherein R₁ represents a substituted or unsubstituted phenyl group or a thienyl group; and R₂ represents an alkyl group having a carbon atom number of from 1 to 6, a phenyl group, a thienyl group or a substituted phenyl group having one to five substituents with a total carbon atom number of from 1 to 14, provided that the two R₂s may combine with each other to form a ring.
(OR₄)₂P—R₃—R₃—P(OR₄)₂ Formula 2
wherein R₃ represents a substituted or unsubstituted phenylene group or a thienylene group; and R₄ represents an alkyl group having a carbon atom number of from 1 to 6, a phenyl group, a thienyl group or a substituted phenyl group having one to five substituents with a total carbon atom number of from 1 to 14, provided that the two R₄s may combine with each other to form a ring.

3. The cellulose ester film of claim 1, wherein the content of the phosphonite compound in the cellulose ester film is from 0.01 to 5 parts by weight, based on 100 parts by weight of the cellulose ester.

4. The cellulose ester film of claim 1, wherein the cellulose ester film further contains a phosphite compound in an amount of from 0.01 to 5 parts by weight, based on 100 parts by weight of the cellulose ester.

5. The cellulose ester film of claim 1, wherein the cellulose ester film further contains at least one selected from the group consisting of a hindered phenol compound, a hindered amine compound and a sulfur-containing compound in an amount of from 0.01 to 5 parts by weight, based on 100 parts by weight of the cellulose ester.

6. The cellulose ester film of claim 1, wherein the cellulose ester is at least one selected from the group consisting of cellulose acetate, cellulose propionate, cellulose butyrate, cellulose acetate propionate, cellulose acetate butyrate, cellulose acetate phthalate, and cellulose phthalate.

7. The cellulose ester film of claim 1, wherein the cellulose ester further contains an ester plasticizer formed from a polyhydric alcohol and a monocarboxylic acid.

8. The cellulose ester film of claim 2, wherein the phosphonite compound is represented by formula 2 above.

9. The cellulose ester film of claim 8, wherein R₄ in formula 2 represents a substituted phenyl group having one to five substituents with a total carbon atom number of from 9 to 14.

10. The cellulose ester film of claim 9, wherein the phosphonite compound is tetrakis(2,4-di-t-butyl-5-methylphenyl) 4,4′-biphenylenediphosphonite.

11. The cellulose ester film of claim 1, wherein the cellulose ester film further contains a carbon radical trapping agent.

12. The cellulose ester film of claim 11, wherein the carbon radical trapping agent is represented by the following formula 5, 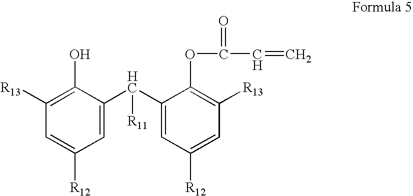
wherein R₁₁ represents a hydrogen atom or an alkyl group having a carbon atom number of from 1 to 10; R₁₂ and R₁₃ independently represent an alkyl group having a carbon atom number of from 1 to 8.

13. The cellulose ester film of claim 11, wherein the carbon radical trapping agent is represented by the following formula 6, 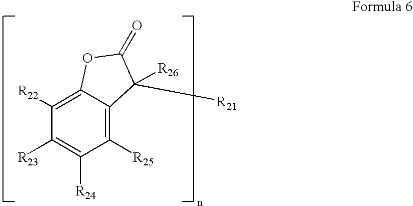
wherein R₂₂ through R₂₅ independently represent a hydrogen atom or a substituent; R₂₆ represents a hydrogen atom or a substituent; and n is 1 or 2, provided that when n is 1, R₂₁ represents a monovalent substituent, and when n is 2, R₂₁ represents a divalent linkage group.

14. A process of manufacturing the cellulose ester film of claim 1, the process comprising the steps of:
heating a mixture comprising cellulose ester and a phosphonite compound at a temperature of from 150 to 300° C. to melt; and
casting the melted mixture on a support.

15. A polarizing plate comprising a polarizing plate protective film, wherein the polarizing plate protective film is the cellulose ester film of claim 1.

16. A polarizing plate comprising a polarizing plate protective film, wherein the polarizing plate protective film is the cellulose ester film manufactured according to the process of claim 14.

17. A liquid crystal display comprising a liquid crystal cell and the polarizing plate of claim 15.

18. A liquid crystal display comprising a liquid crystal cell and the polarizing plate of claim 16.
